(19) United States
(12) Patent Application Publication
(10) Pub. No.: US 2014/0184189 A1
(43) Pub. Date: Jul. 3, 2014

(54) INDUCTIVELY ASSISTED SWITCHED CAPACITOR DC-DC CONVERTER

(71) Applicant: Loai Galal Bahgat Salem, Giza (EG)

(72) Inventor: Loai Galal Bahgat Salem, Giza (EG)

(73) Assignee: Loai Galal Bahgat Salem, Giza (EG)

(21) Appl. No.: 13/975,333

(22) Filed: Aug. 24, 2013

Related U.S. Application Data
(60) Provisional application No. 61/748,356, filed on Jan. 2, 2013.

(51) Int. Cl. H02M 3/158

(52) U.S. Cl. CPC H02M 3/158
USPC 323/299

(57) ABSTRACT

In general, in one aspect, a direct-current to direct-current (DC-DC) converter adapted for converting a plurality of input voltages to a plurality of output voltages, comprising: a plurality of capacitors, a plurality of inductors, and a plurality of switches, and said switches interconnect said capacitors creating a switched capacitor circuit capable of operating at one of a plurality of distinct conversion ratios, wherein said plurality of inductors provide continuous modes from the plurality of distinct ratios and selection of an overall converter mode is based on an input voltage received.

### CROSS REFERENCE TO RELATED APPLICATIONS

This application claims priority to U.S. Provisional Patent Application No. 61/748,356, filed Jan. 2, 2013 by the present inventor.

### BACKGROUND

Direct-current to direct-current (DC-DC) converters can be implemented using inductors or capacitors as the energy storage devices. Switched inductor (SL) DC-DC converters use a chopper circuit to generate a square voltage signal from the input battery DC voltage. An output inductive filter is used to extract the DC component of the square signal. Thus, the voltage conversion ratio from the input battery to the supplied circuit can be continuously controlled through the duty cycle of the square voltage signal. On the other hand, switched capacitor (SC) DC-DC converters utilize different topologies of capacitors to provide discrete voltage conversion ratios.

As opposed to SL voltage converters, SC voltage converters suffer from fixed voltage conversion ratio, m:n, from the input to the output terminals. Indeed, SC converters can only deliver output voltages with high efficiency at discrete ratios of the input voltage. In order to obtain continuous voltage regulation under line and load variations, the SC equivalent output resistance is modulated, through the switching frequency, and hence the SC is essentially operated as a linear regulator. Therefore, the SC efficiency degrades severely as the desired output level deviates from the SC unloaded voltage level.

The intuitive method to solve such problem in SC DC-DC converters is to change the unloaded conversion ratio, m:n, to obtain the desired output voltage, where the voltage drop across the converter's output resistance is minimized. However, large number of conversion ratios substantially increases the number of components and eventually the converter's complexity. Therefore, the conversion ratio is only changed when the output falls substantially below the unloaded conversion ratio, m:n, such that the linear regulation through the output resistance is limited and efficiency is kept within a reasonable range.

### BRIEF DESCRIPTION OF THE DRAWINGS

The features and advantages of the various embodiments will become apparent from the following detailed description in which:

FIG. 1A illustrates an example switched capacitor circuit providing a 2:1 transformation (voltage conversion ratio) of an input voltage;

FIG. 1B illustrates an example timing diagram of the operation of the switch pairs for the switched capacitor circuit of FIG. 1A to provide a 2:1 voltage conversion ratio;

FIG. 1C illustrates an example equivalent circuit of the switched capacitor of FIG. 1;

FIG. 1D illustrates an example switched circuit providing continuous transformation ratios (modes) of an input voltage;

FIG. 1E illustrates an example timing diagram of the operation of the switches for the switched circuit in FIG. 1D;

FIG. 1F illustrates an example switched circuit providing continuous transformation ratios (modes) of an input voltage;

FIG. 1G illustrates an example timing diagram of the operation of the switches for the switched circuit 1F;

FIG. 2A illustrates an example switched capacitor circuit providing the average of two input voltages;

FIG. 2B illustrates an example timing diagram of the operation of the switch pairs for the switched capacitor circuit in FIG. 2A to provide the average of two input voltages;

FIG. 3A illustrates an example switched circuit providing continuous transformation ratios (modes) larger than 1/2 of an input voltage;

FIG. 3B illustrates an example timing diagram of the operation of the switches for the switched circuit in FIG. 3A;

FIG. 3C illustrates example phases for the four phases of the circuit in FIG. 3A;

FIG. 3D illustrates an example timing diagram of the operation of the switches for the switched circuit in FIG. 3A;

FIG. 3E illustrates example phases for the four phases of the circuit in FIG. 3A;

FIG. 3F illustrates an example equivalent circuit of the circuit in FIG. 3A;

FIG. 4A illustrates an example switched circuit providing continuous transformation ratios (modes) smaller than 1/2 of an input voltage;

FIG. 4B illustrates an example timing diagram of the operation of the switches for the switched circuit in FIG. 4A;

FIG. 4C illustrates example phases for the four phases of the circuit in FIG. 4A;

FIG. 4D illustrates an example timing diagram of the operation of the switches for the switched circuit in FIG. 3A;

FIG. 4E illustrates example phases for the four phases of the circuit in FIG. 4A;

FIG. 4F illustrates an example equivalent circuit of the circuit in FIG. 4A;

FIG. 5 illustrates an example switched circuit providing continuous transformation ratios (modes) at 1/2, higher, or lower, e.g. 0≦Vₒᵤₜ/Vᵢₙ≦1, of an input voltage;

FIG. 6 illustrates an example power delivery path (or signal path) from an on-board VR (or signal source/sink) to a die;

FIG. 7A illustrates an example mutual coupling between two inductors;

FIG. 7B illustrates the effect of such mutual inductance M assuming the same current change;

FIG. 7C illustrates an example power delivery subsystem for routing power;

FIG. 7D illustrates an example switched circuit utilizing parasitic inductors;

FIG. 8 illustrates an example switched capacitor circuit that may be utilized to provide five voltage conversion ratios: 1/2, 2/3, 1/3, 3/4, and 1/4 of an input voltage Vᵢₙ;

FIG. 9A illustrates an example switched capacitor circuit that may be utilized to provide five voltage conversion ratios: 1/2, 2/3, 1/3, 3/4, and 1/4 of an input voltage Vᵢₙ;

FIG. 9B illustrates a block diagram of the circuit in FIG. 9A;

FIG. 10 illustrates an example switched circuit providing continuous transformation ratios (modes), e.g. 0≦Vₒᵤₜ/Vᵢₙ≦1, of an input voltage by using the switched capacitor circuit of five transformation modes 1/2, 2/3, 1/3, 3/4, and 1/4;

FIG. 11A illustrates an example equivalent circuit for the circuit in FIG. 10 when the switched capacitor circuit is operated in the mode 3/4;

FIG. 11B illustrates an example equivalent circuit for the circuit in FIG. 10 when the switched capacitor circuit is operated in the mode 1/3;

FIG. 12 illustrates an example switched circuit providing continuous transformation ratios (modes) using a Ladder topology of five steps (e.g. 1/5, 2/5, 3/5, 4/5, 1);

FIG. 13A illustrates an example method for reducing noise of a switched circuit; and

FIG. 13B illustrates an example timing of the driving clocks clk0, clk1, clk(N−1).

### DETAILED DESCRIPTION

Switched circuits can be utilized as step down/step up power converters. The switched capacitor circuits provide a lossless (or substantially lossless) voltage conversion at a ratio (mode) that is characteristic of circuit topology. A resistive mechanism can be used to regulate its output voltage at a level lower than the converted level. The regulation mechanism is resistive similar to a linear regulator where voltage regulation is achieved by dissipating the excess power (lossy). Embodiments are shown and described below in greater detail.

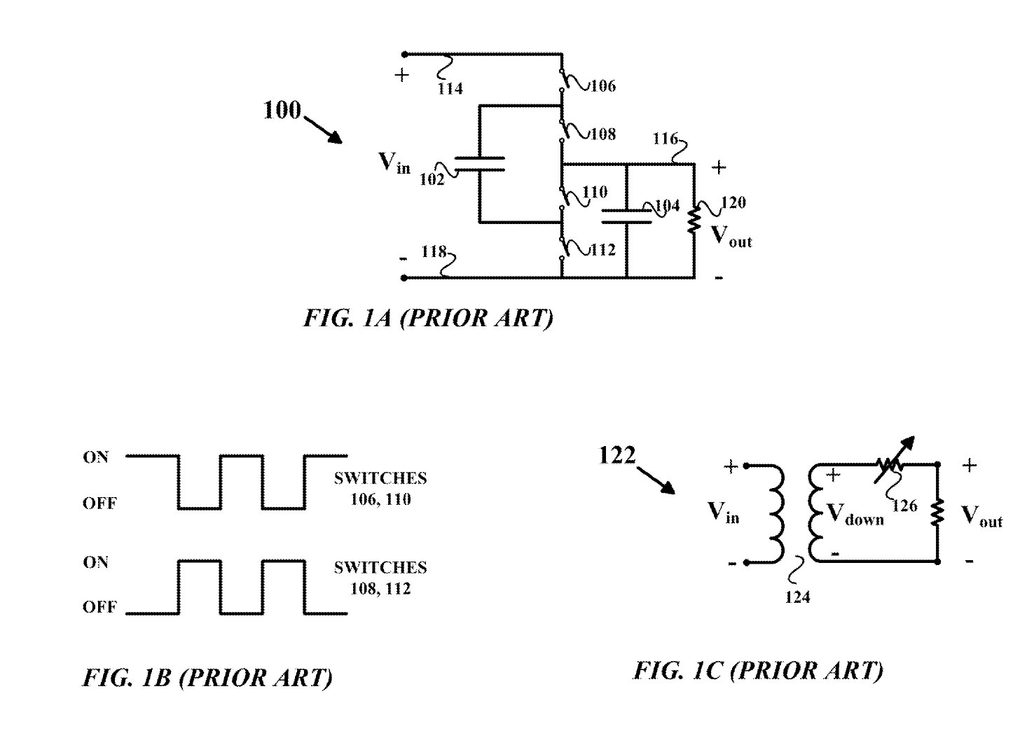

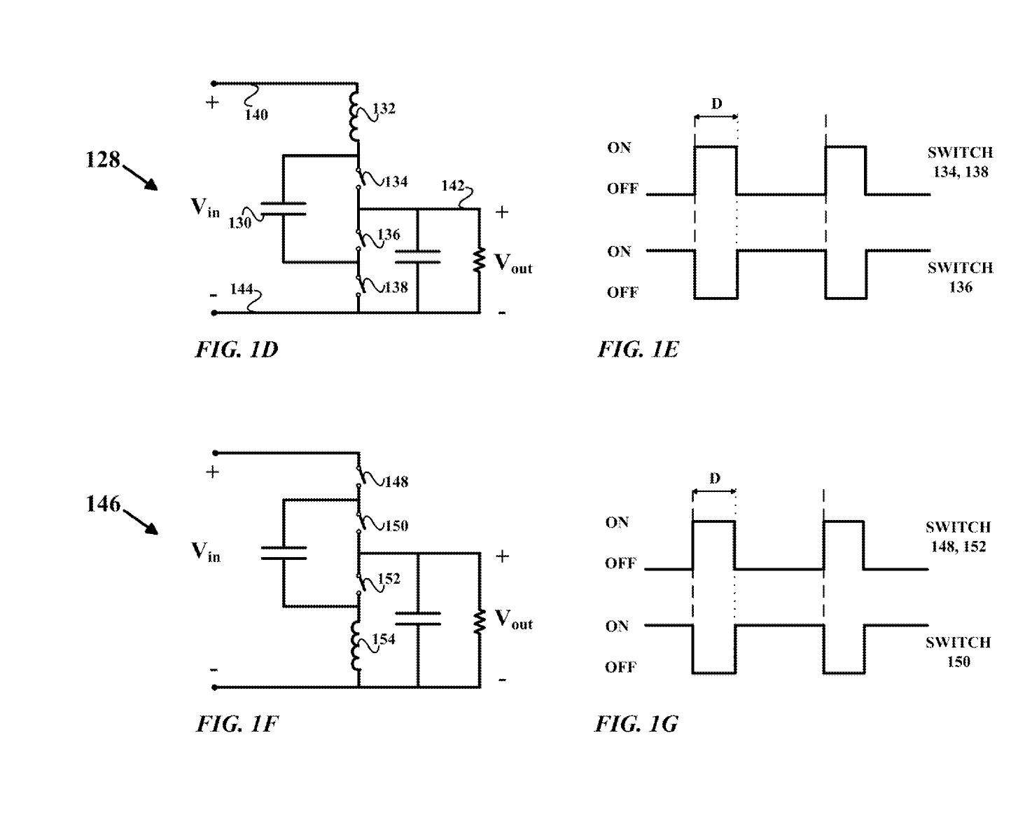

FIG. 1A illustrates an example switched capacitor circuit 100 providing a 2:1 transformation (voltage conversion ratio) of an input voltage (provides output that is 1/2 of input). The circuit 100 may include two capacitors 102, 104, four switches 106, 108, 110, 112, an input port 114 to receive an input voltage (Vᵢₙ), an output port 116 to produce an output voltage (Vₒᵤₜ), and a ground port 118 to provide a common level for the input voltage Vᵢₙ and the output voltage Vₒᵤₜ. The switches may be one or more transistors. The switches 106, 108, 110, 112 are connected in series. The input voltage (Vᵢₙ) is provided across the four series connected switches 106, 108, 110, 112. The capacitor 102 (flying capacitor) is connected between: the input port 114 and the output port 116, or the output port 116 and the ground port 118, based on the operation of the switches 106, 108, 110, 112. When the switches 106, 110 are closed and the switches 108, 112 are open the capacitor 102 is connected between the input port 114 and the output port 116 and when switches 108, 112 are closed and the switches 106, 110 are open the capacitor 102 is connected between the output port 116 and the ground port 118. The pairs of switches 106/110, 108/112 are switched on and off alternatively at a constant frequency.

FIG. 1B illustrates an example timing diagram of the operation of the switch pairs for the switched capacitor circuit 100 to provide a 2:1 voltage conversion ratio. The switch pair 106/110 is on while the switch pair 108/112 is off and vice versa. The on duration (e.g., duty cycle) is approximately half of the cycle time for each pair of switches. It should be noted that the signals are illustrated as on and off signals for ease of illustration. These signals may equate to voltages that are applied to transistors in order to have the transistor act as an open or closed switch respectively. The voltages applied to turn a switch on may be high while the voltage applied to turn the switch off may be low or could be the opposite. The level of the high and low voltages may be dependent on the implementation.

Referring back to FIG. 1A, the output voltage (Vₒᵤₜ) is measured across capacitor 104. This Vₒᵤₜ is provided across the load (e.g., microprocessor). The resistance of the load (R_{L}) 120 determines the current flowing through the load. The circuit 100 may provide a lossless (or substantially lossless) 2 to 1 voltage conversion ratio.

FIG. 1C illustrates an example equivalent circuit 122. The equivalent circuit 122 may provide closed loop voltage regulation and include a transformer 124 and a variable resistor 126. The transformer 124 may step down Vᵢₙ by a factor of 2 so that the downshifted voltage is half of Vᵢₙ, V_{down}=Vᵢₙ/2. The 2:1 voltage conversion ratio may be lossless (or substantially lossless). The variable resistor 126 may provide regulation of Vₒᵤₜ (further adjust the V_{down} down by dissipating the excess power). The regulation of Vₒᵤₜ is lossy and accordingly affects the efficiency of the overall down-conversion.

Accordingly, the switched capacitor circuit 100 may be used for stepping up or down voltages at very high efficiencies where line regulation is not a criterion. The switched capacitor circuit 100 may be utilized as a voltage regulator (VR) for low power applications. However, the switched capacitor circuit 100 may not be suitable to generate a regulated output voltage for medium or high power applications especially with a wide range of input voltages due to the lossy regulation mechanism (resistance).

FIG. 1D illustrates an example switched circuit 128 providing continuous transformation ratios (modes) of an input voltage. The circuit 128 may include a capacitor 130, an inductor 132, three switches 134, 136, 138, an input port 140 to receive an input voltage (Vᵢₙ), an output port 142 to produce an output voltage (Vₒᵤₜ), and a ground port 144 to provide a common level for the input voltage Vᵢₙ and the output voltage Vₒᵤₜ. The switches may be one or more transistors, or one or more diodes. The inductor 132 is connected in series with the three switches and the input voltage (Vᵢₙ) is provided across the series connected inductor 132 and switches.

The inductor 132 may be connected in series or in parallel with the flying capacitor 130 based on the operation of the three switches 134-138. When the switch pair 134/138 is closed while the other switch 136 is open the inductor 132 is connected in parallel with the capacitor 130; the inductor 132 is connected between the input port 140 and the output port 142 and the capacitor 130 is connected between the output port 142 and the ground port 144. When the switch 136 is closed while the other switches 134, 138 are open the inductor 132 is connected in series with the capacitor 130 between the input port 140 and the output port 142. The switch pair 134/138 and the switch 136 may be switched on and off alternatively at a constant frequency.

FIG. 1E illustrates an example timing diagram of the operation of the switches for the switched circuit 128. The switch pair 134/138 is on for approximately D % while the switch 136 is off. The switch 136 is on for approximately (1-D) % while the switch pair 134/138 is off. The duty cycle D % may be proportional to the desired conversion ratio, Vₒᵤₜ/Vᵢₙ. The output voltage (Vₒᵤₜ) is provided to the load (e.g. microprocessor).

FIG. 1F illustrates an example switched circuit 146 providing continuous transformation ratios (modes) of an input voltage. The circuit 146 may include similar components as the circuit 128. However, the inductor 154 is connected to the ground side.

FIG. 1G illustrates an example timing diagram of the operation of the switches for the switched circuit 146.

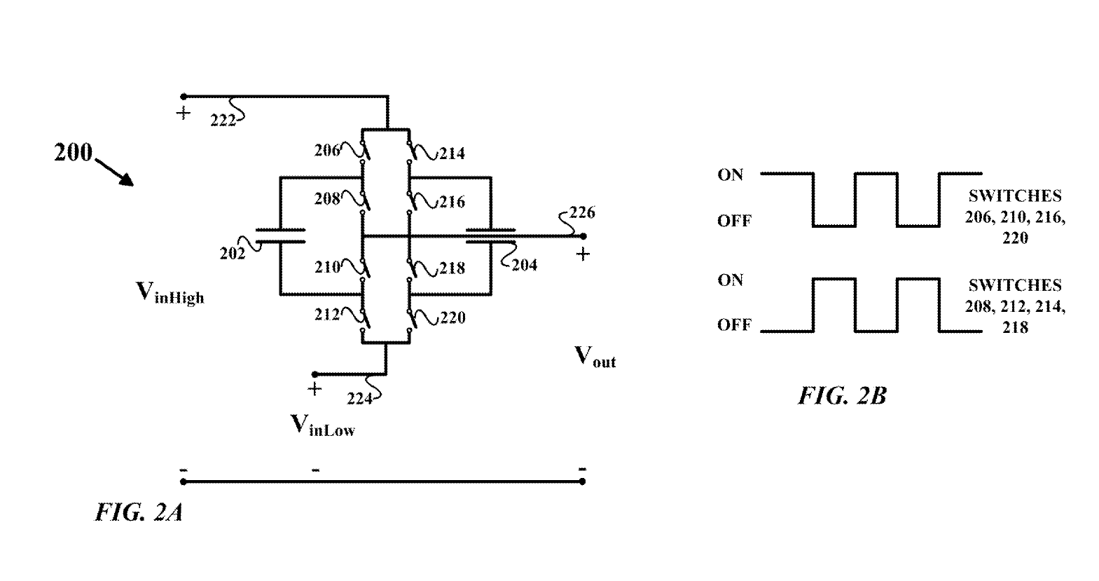

FIG. 2A illustrates an example switched capacitor circuit 200 providing the average of two input voltages. The circuit 200 may include two capacitors 202, 204, eight switches 206, 208, 210, 212, 214, 216, 218, 220, an input port 222 to receive an input voltage (V_{inHigh}), a ground port 224 to receive an input voltage (V) and an output port 226 to produce an output voltage (Vₒᵤₜ). The switches may be one or more transistors. The switches 206, 208, 210, 212 are connected in series as well as the switches 214, 216, 218, 220. The switches 208, 210, 216, 218 are connected to the output port 226.

The switched capacitor circuit 200 takes two inputs, V_{inHigh} and V_{inLow} through the input port 222 and the ground port 224 respectively, and produces at the output port 226 the output voltage (Vₒᵤₜ) which is the average of the input voltages, Vₒᵤₜ=(V_{inHigh}+V_{inLow})/2, or below, Vₒᵤₜ<(V_{inHigh}+V_{inLow})/2. The flying capacitors 202, 204 may be symmetric and are out of phase to guarantee continuous input current through the input port 222. When the switch pairs 206/210, 216/220 are closed while the other switches are open the capacitor 202 is connected between the input port 222 and the output port 226 while the capacitor 204 is connected between the output port 226 and the ground port 224. When the switch pairs 208/212, 214/218 are closed while the other switches are open the capacitor 202 is connected between the output port 226 and the ground port 224 while the capacitor 204 is connected between the input port 222 and the output port 226. The switch groups 206/210, 216/220 and 208/212, 214/218 are switched on and off alternatively at a constant frequency. The input port 222 (ground port 224) would see the same amount of charge drawn in each half of the switching cycle. The input port 222 and the ground port 224 may be swapped without affecting the operation of the switched capacitor circuit 200.

FIG. 2B illustrates an example timing diagram of the operation of the switch pairs for the switched capacitor circuit 200 to provide the average of two input voltages. The switch pairs 206/210, 216/220 are on while the switch pairs 208/212, 214/218 are off and vice versa. The on cycle is approximately half of the cycle time for each pair of switches. It should be noted that the signals are illustrated as on and off signals for ease of illustration.

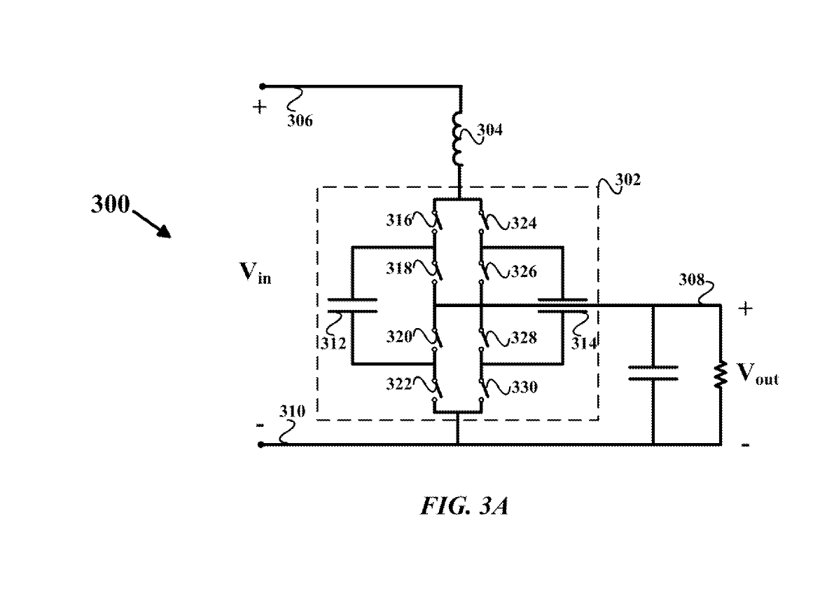

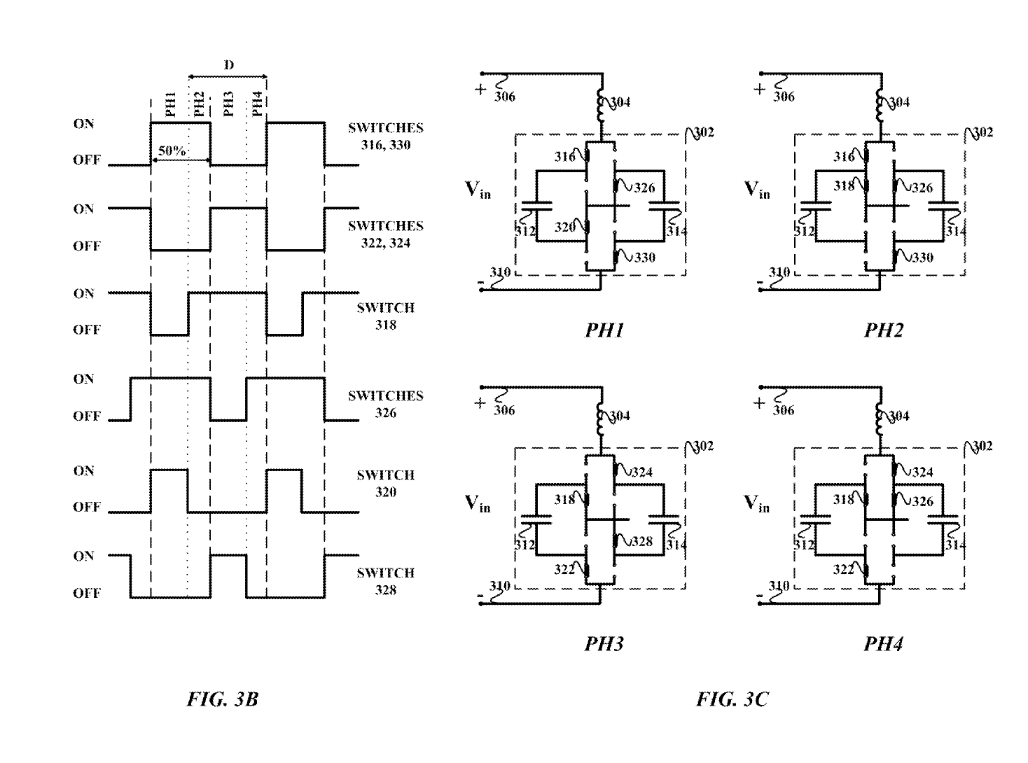

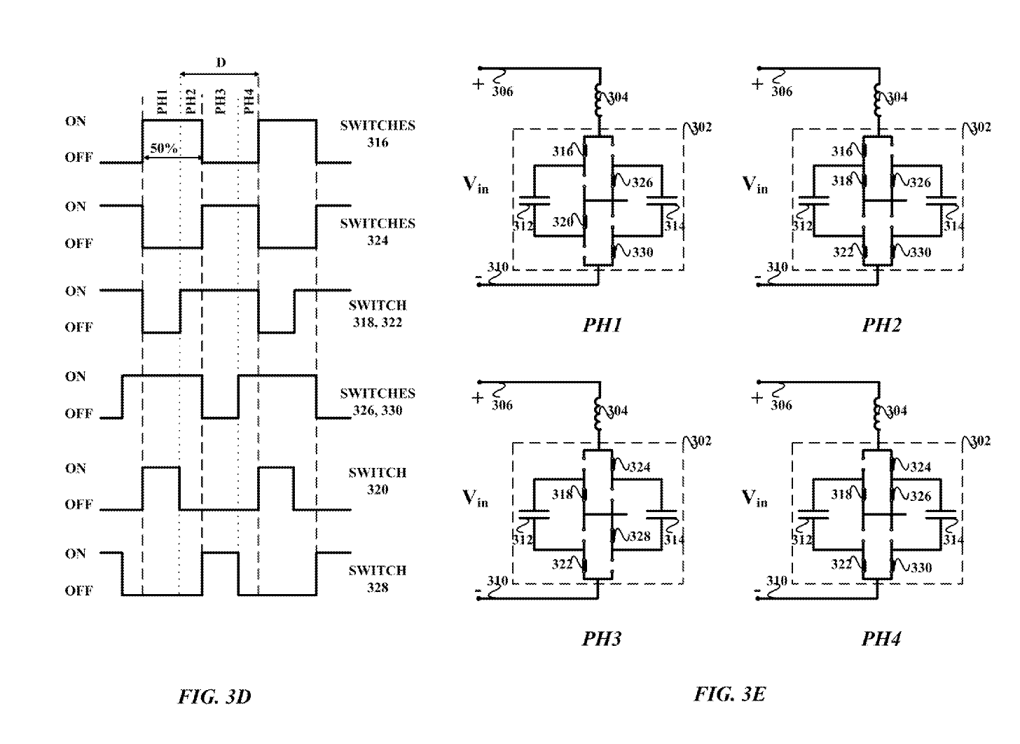

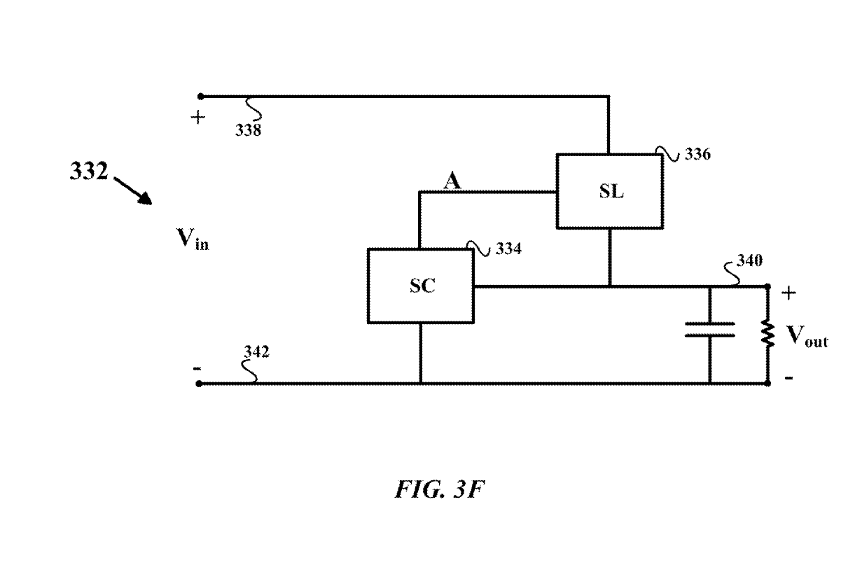

FIG. 3A illustrates an example switched circuit 300 providing continuous transformation ratios (modes) larger than 1/2 of an input voltage. The circuit 300 may include a switched capacitor circuit 302 (e.g., 200), an inductor 304, an input port 306 to receive an input voltage (Vᵢₙ), an output port 308 to produce an output voltage (Vₒᵤₜ), and a ground port 310 to provide a common level for the input voltage Vᵢₙ and the output voltage Vₒᵤₜ. The switches may be one or more transistors. The inductor 304 is connected in series with the switched capacitor circuit 302 and the input voltage (Vᵢₙ) is provided across the series connected inductor 304 and circuit 302.

The inductor 304 may be connected in series or in parallel with one of the flying capacitors 312, 314 based on the operation of the eight switches 316-330. When the switch pairs 316/320, 326/330 are closed while the other switches are open the inductor 304 is connected in series with the capacitor 312 while the capacitor 314 is connected between the output port 308 and the ground port 310. When the switch pairs 316/318, 326/330 are closed while the other switches are open the inductor 304 is connected between the input port 306 and the output port 308 while the capacitor 314 is connected between the output port 308 and the ground port 310. When the switch pairs 324/328, 318/322 are closed while the other switches are open the inductor 304 is connected in series with the capacitor 314 while the capacitor 312 is connected between the output port 308 and the ground port 310. When the switch pairs 324/326, 318/322 are closed while the other switches are open the inductor 304 is connected between the input port 306 and the output port 308 while the capacitor 312 is connected between the output port 308 and the ground port 310. These four mentioned states (phases) may be repeated at a constant frequency.

FIG. 3B illustrates an example timing diagram of the operation of the switches for the switched circuit 300. The circuit 300 may switch through four phases: PH1, PH2, PH3, PH4. FIG. 3C illustrates example phases for the four phases of the circuit 300. The switch pair 316/330 is on for approximately 50% duty cycle while the switch pair 322/324 is off and vice versa. The switches 318, 326 are on for approximately D % and their timing is approximately 180 degrees phase shifted. The switches 320, 328 are on for approximately (1-D) % and their timing is approximately 180 degrees phase shifted. The duty cycle D % may follow the desired conversion ratio, Vₒᵤₜ/Vᵢₙ. The output voltage (Vₒᵤₜ) is provided to the load (e.g. microprocessor).

The inductor 304 handles approximately half of the load current I, at 1/2 voltage conversion ratio, D=50%, which might be of importance for low-quality inductors (inductors in integrated circuits). The amount of current through the inductor 304 may be proportional to D, and hence as the conversion ratio deviates from the switched capacitor 1/2 fixed mode the inductor may handle larger current than I_{L}/2. The resistive regulation mechanism 126 may be replaced with the inductor 304 to provide continuous lossless (or substantially lossless) voltage conversion ratio (mode), larger than or equal to 1/2, e.g. 1/2≦Vₒᵤₜ/Vᵢₙ≦1, of the switched capacitor circuit 302.

FIG. 3D illustrates an example timing diagram of the operation of the switches for the switched circuit 300. The circuit 300 may switch through four phases: PH1, PH2, PH3, PH4. FIG. 3E illustrates example phases for the four phases of the circuit 300. The switch 316 is on for approximately 50% duty cycle while the switch 324 is off and vice versa. The switch pairs 318/322, 326/330 are on for approximately D % and their timing is approximately 180 degrees phase shifted. The switches 320, 328 are on for approximately (1−D) % and their timing is approximately 180 degrees phase shifted. The duty cycle D % may follow the desired conversion ratio, Vₒᵤₜ/Vᵢₙ. The output voltage (Vₒᵤₜ) is provided to the load (e.g. microprocessor). Such operation may provide better efficiency, where both capacitors 312, 314 are utilized through the whole cycle to provide output charge.

Other timing diagrams may be followed for the switches 316-330 enabling the inductor 304 to provide continuous lossless (or substantially lossless) voltage conversion ratio (mode) above the 2:1 fixed ratio of the switched capacitor circuit 302.

FIG. 3F illustrates an example equivalent circuit 332 of the circuit 300. The equivalent circuit 332 may include a switched capacitor circuit 334 (SC), a switched inductor circuit 336 (SL), an input port 338 to receive an input voltage (Vᵢₙ), an output port 340 to produce an output voltage (Vₒᵤₜ), and a ground port 342. The switched circuits 334, 336 are stacked on top of each other and the input voltage (Vᵢₙ) is provided across the stack. The input port of the switched capacitor circuit 334 is connected to the output port of the switched inductor circuit 336 (node A). The ground port of the switched inductor circuit 336 is connected to the output port of the circuit 334. Vₒᵤₜ is measured from the output port of the switched capacitor circuit 334. Using this arrangement and operating the circuits according to FIG. 3B, or FIG. 3D timing may result in an overall continuous lossless (or substantially lossless) voltage conversion ratio (mode) of 2:1 or higher.

Accordingly, referring back to FIG. 3A, the switched circuit 300 may be used for stepping up (by swapping input port 306 and ground port 308) or down voltages at very high efficiencies. The switched circuit 300 may be utilized as a voltage regulator (VR) for various applications. The switched circuit 300 may be suitable to generate a regulated output voltage for low, medium, or high power applications especially with a wide range of input/output voltages due to the lossless (or substantially lossless) regulation mechanism (inductively assisted SC).

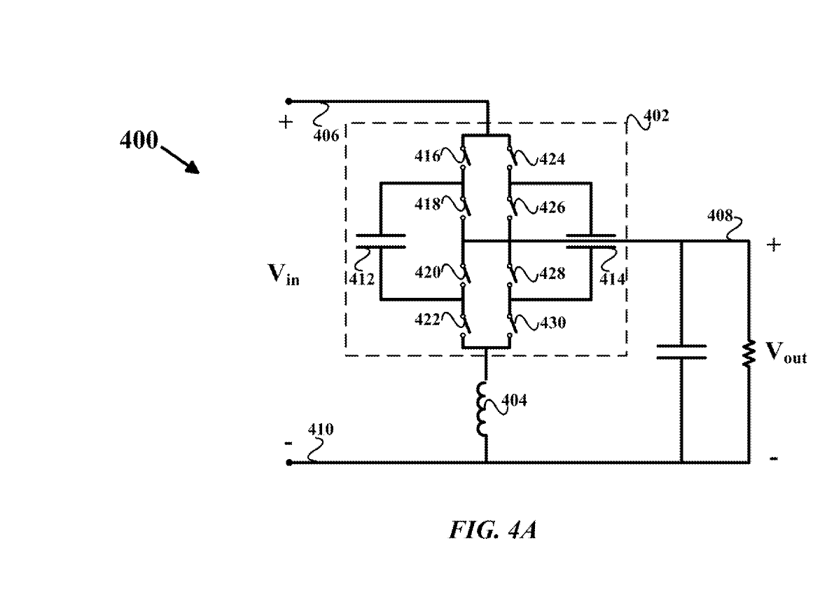

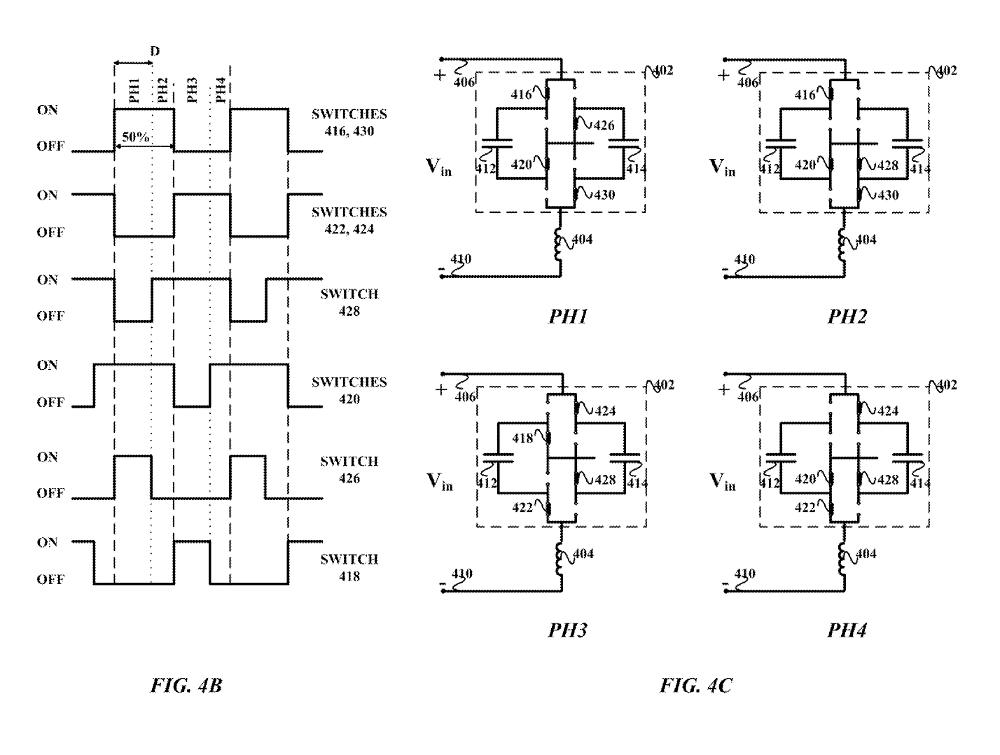

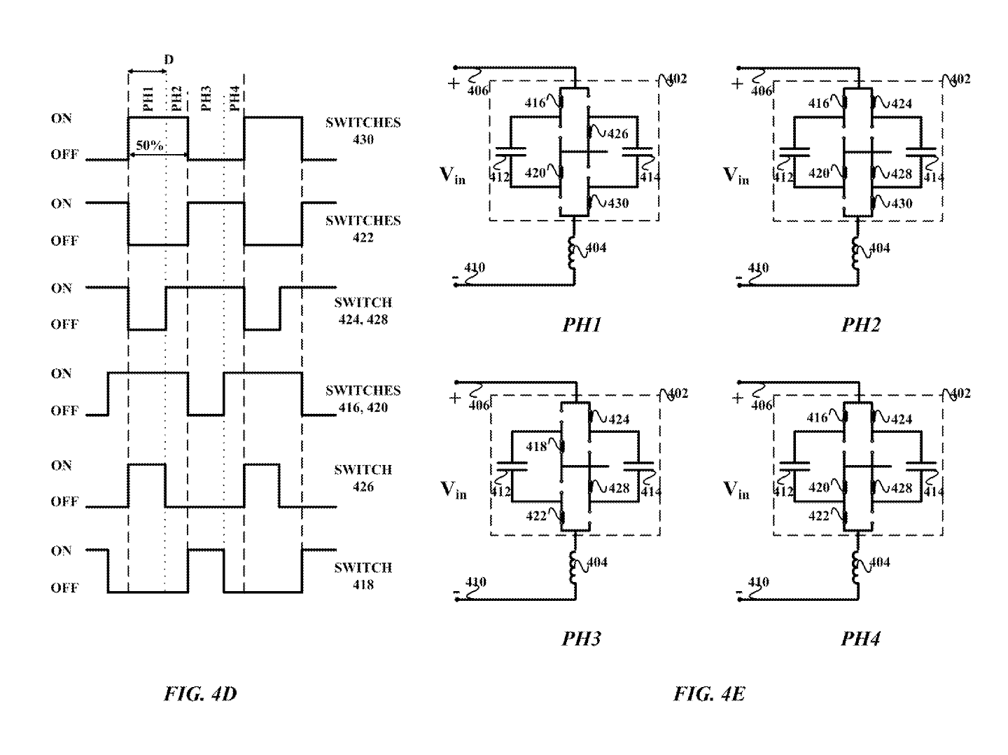

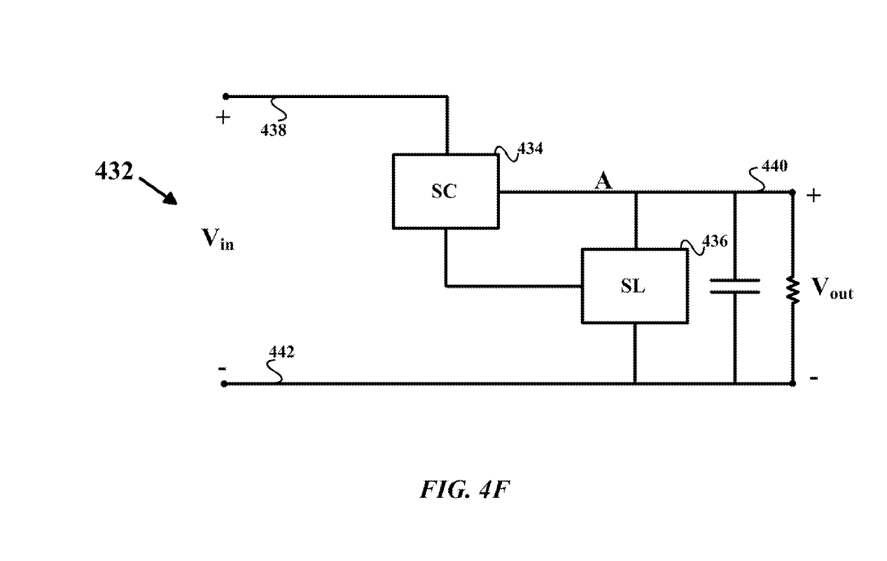

FIG. 4A illustrates an example switched circuit 400 providing continuous transformation ratios (modes) smaller than 1/2 of an input voltage. The circuit 400 may include a switched capacitor circuit 402 (e.g., 200), an inductor 404, an input port 406 to receive an input voltage (Vᵢₙ), an output port 408 to produce an output voltage (Vₒᵤₜ), and a ground port 410 to provide a common level for the input voltage Vᵢₙ and the output voltage Vₒᵤₜ. The switches may be one or more transistors. The inductor 404 is connected in series with the switched capacitor circuit 402 and the input voltage (Vᵢₙ) is provided across the series connected circuit 402 and inductor 404.

The inductor 404 may be connected in series or in parallel with one of the flying capacitors 412, 414 based on the operation of the eight switches 416-430. When the switch pairs 416/420, 426/430 are closed while the other switches are open the inductor 404 is connected in series with the capacitor 414 while the capacitor 412 is connected between the input port 406 and the output port 408. When the switch pairs 416/420, 428/430 are closed while the other switches are open the inductor 404 is connected between the output port 408 and the ground port 410 while the capacitor 412 is connected between the input port 406 and the output port 408. When the switch pairs 424/428, 418/422 are closed while the other switches are open the inductor 404 is connected in series with the capacitor 412 while the capacitor 414 is connected between input port 406 and the output port 408. When the switch pairs 424/428, 420/422 are closed while the other switches are open the inductor 404 is connected between the output port 408 and the ground port 410 while the capacitor 414 is connected between the input port 406 and the output port 408. These four mentioned states (phases) may be repeated at a constant frequency.

FIG. 4B illustrates an example timing diagram of the operation of the switches for the switched circuit 400. The circuit 400 may switch through four phases: PH1, PH2, PH3, PH4. FIG. 4C illustrates example phases for the four phases of the circuit 400. The switch pair 416/430 is on for approximately 50% duty cycle while the switch pair 422/424 is off and vice versa. The switches 420, 428 are on for approximately (1−D) % and their timing is approximately 180 degrees phase shifted. The switches 418, 426 are on for approximately D % and their timing is approximately 180 degrees phase shifted. The duty cycle D % may follow the desired conversion ratio, Vₒᵤₜ/Vᵢₙ. The output voltage (Vₒᵤₜ) is provided to the load (e.g. microprocessor).

The inductor 404 handles approximately half of the load current I_{L} at 1/2 voltage conversion ratio, D=50%, which might be of importance for low-quality inductors (inductors in integrated circuits). The amount of current through the inductor 404 may be proportional to (1−D), and hence as the conversion ratio deviates from the switched capacitor 1/2 fixed mode the inductor may handle larger current than I_{L}/2. The resistive regulation mechanism 126 may be replaced with the inductor 404 to provide continuous lossless (or substantially lossless) voltage conversion ratio (mode), lower than or equal to 1/2, e.g. 0≦Vₒᵤₜ/Vᵢₙ≦1/2, of the switched capacitor circuit 402.

FIG. 4D illustrates an example timing diagram of the operation of the switches for the switched circuit 400. The circuit 400 may switch through four phases: PH1, PH2, PH3, PH4. FIG. 4E illustrates example phases for the four phases of the circuit 400. The switch 430 is on for approximately 50% duty cycle while the switch 422 is off and vice versa. The switch pairs 416/420, 424/428 are on for approximately (1−D) % and their timing is approximately 180 degrees phase shifted. The switches 418, 426 are on for approximately D % and their timing is approximately 180 degrees phase shifted. The duty cycle D % may follow the desired conversion ratio, Vₒᵤₜ/Vᵢₙ. The output voltage (Vₒᵤₜ) is provided to the load (e.g. microprocessor). Such operation may provide better efficiency, where both capacitors 412, 414 are utilized through the whole cycle to provide output charge.

Other timing diagrams may be followed for the switches 416-430 enabling the inductor 404 to provide continuous lossless (or substantially lossless) voltage conversion ratio (mode) below the 2:1 fixed ratio of the switched capacitor circuit 402.

FIG. 4F illustrates an example equivalent circuit 432 of the circuit 400. The equivalent circuit 432 may include a switched capacitor circuit 434 (SC), a switched inductor circuit 436 (SL), an input port 438 to receive an input voltage (Vᵢₙ), an output port 440 to produce an output voltage (Vₒᵤₜ), and a ground port 442. The switched circuits 434, 436 are stacked on top of each other and the input voltage (Vᵢₙ) is provided across the stack. The input port of the switched inductor circuit 436 is connected to the output port of the switched capacitor circuit 434 (node A). The ground port of the switched capacitor circuit 434 is connected to the output port of the circuit 336. Vₒᵤₜ is measured from the output port of the switched capacitor circuit 334. Using this arrangement and operating the circuits according to FIG. 4B, or FIG. 4D timing may result in an overall continuous lossless (or substantially lossless) voltage conversion ratio (mode) of 2:1 or lower.

Accordingly, referring back to FIG. 4A, the switched circuit 400 may be used for stepping up (by swapping input port 406 and ground port 408) or down voltages at very high efficiencies. The switched circuit 400 may be utilized as a voltage regulator (VR) for various applications. The switched circuit 400 may be suitable to generate a regulated output voltage for low, medium, or high power applications especially with a wide range of input/output voltages due to the lossless (or substantially lossless) regulation mechanism (inductively assisted SC).

While not illustrated the inductors 304 (FIG. 3A) and 404 (FIG. 4A) may be the same inductor where it is switched from being connected in series with the input port (of the circuit 300 or 400) to being connected in series with the ground port (of the circuit 300 or 400) by utilizing some type of switching mechanism and thus a continuous lossless (or substantially lossless) voltage conversion ratio (mode) of 2:1, higher, or lower, e.g. 0≦Vₒᵤₜ/Vᵢₙ≦1, may be provided through the circuit 300 or 400.

Utilizing a fixed voltage conversion ratio switched capacitor circuit would either be inefficient because it relied heavily on the lossy resistance mechanism to regulate Vₒᵤₜ to the desired level or would not be able to provide the necessary Vₒᵤₜ for certain Vᵢₙ regions. In the above noted example, if the 2:1 voltage conversion ratio is the only available mode while the desired output voltage Vₒᵤₜ is 1V from 8V, a substantial reduction/regulation (e.g., from 4V to 1V) would be provided by the resistive regulation mechanism (lossy), which would result in an inefficient regulation. On the other hand, if the input voltage Vᵢₙ becomes 5V (e.g. system battery voltage decays from 8V after operation) and the desired Vᵢₙ is 4V, the 2:1 mode would result in V_{down} of 2.5V, below the desired Vₒᵤₜ. Fortunately, utilizing the circuits 300, 400 may provide, continuous, V_{down} at (or near) the desired Vₒᵤₜ.

The mode of the circuits 300, 400 may be varied, continuously, based on what Vᵢₙ is received and what Vₒᵤₜ is desired. The mode that the circuit 300 or 400 is operated in may be controlled by the signals provided thereto (e.g., the signals for the switches 316-330 or 416-430). A controller (not illustrated) may be utilized to detect desired Vₒᵤₜ and select the appropriate mode. The controller may provide the appropriate switch signals or may manipulate the switching signals that are provided.

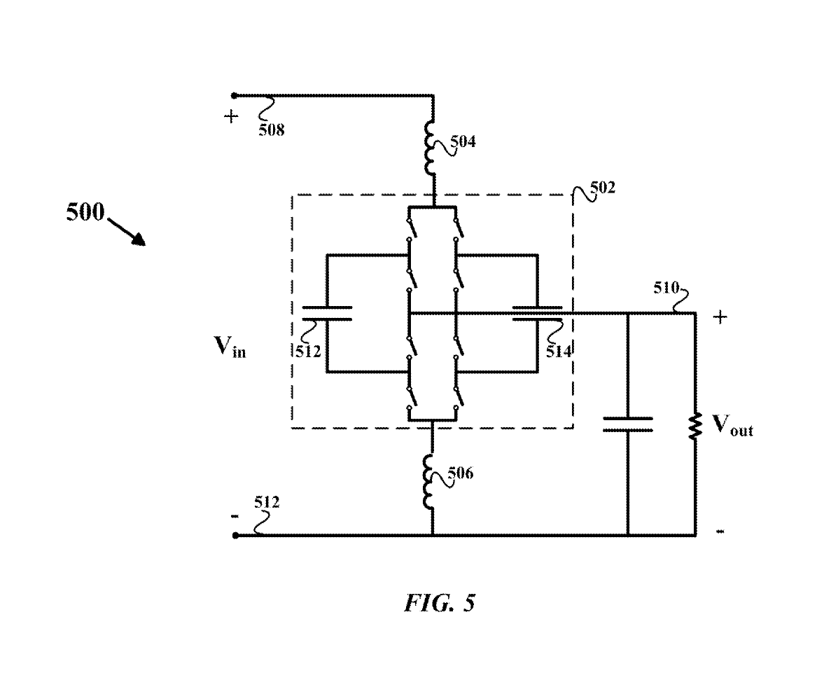

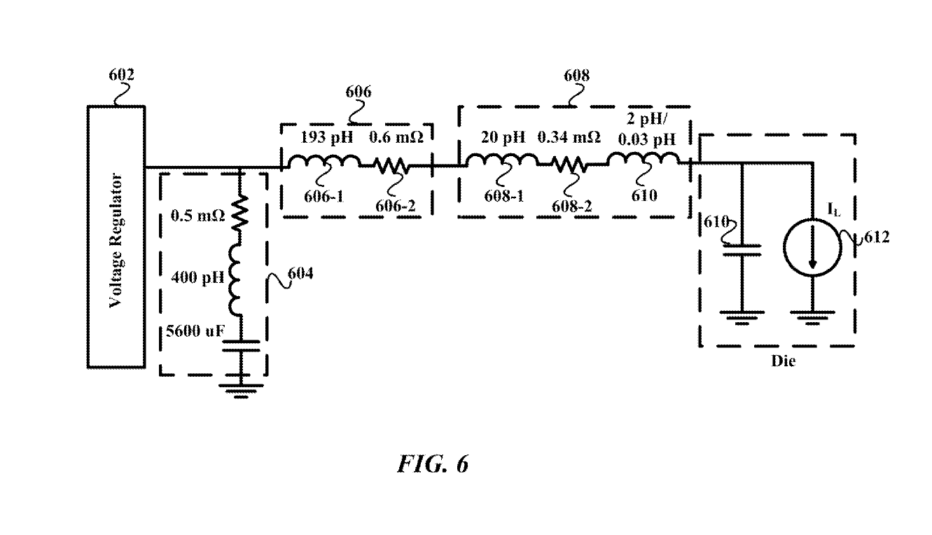

FIG. 5 illustrates an example switched circuit 500 providing continuous transformation ratios (modes) at 1/2, higher, or lower, e.g. 0≦Vₒᵤₜ/Vᵢₙ≦1, of an input voltage. The circuit 500 may include a switched capacitor circuit 502 (e.g., 200), two inductors 504, 506, an input port 508 to receive an input voltage (Vᵢₙ), an output port 510 to produce an output voltage (Vₒᵤₜ), and a ground port 512 to provide a common level for the input voltage Vᵢₙ and the output voltage Vₒᵤₜ. The switches may be one or more transistors.

The circuit 500 may be operated as the circuit 300 to provide continuous modes at 1/2 or higher, e.g. Vₒᵤₜ/Vᵢₙ≧1/2. In such embodiment, the inductor 506 may hold the current continuous (or substantially continuous) instead of the impulsive current through either capacitor 512, 514, and hence loss may be reduced. The circuit 500 may be operated as the circuit 400 to provide continuous modes at 1/2 or lower, e.g. Vₒᵤₜ/Vᵢₙ≦1/2. In such embodiment, the inductor 504 may hold the current continuous (or substantially continuous) instead of the impulsive current through either capacitor 512, 514, and hence loss may be reduced.

In either embodiment, the current of the capacitors 512, 514 is forced continuous, thus methods for keeping the current continuous during phase switching events may be implemented. Resonance may occur between the flying capacitors and the inductors 504, 506 for low values of switch equivalent resistance. When the switching frequency is slower than the resonance frequency, power reflection might occur and little net current may be transferred each period, yielding higher loss. It may be better to avoid such case by operating at higher frequencies.

When D=50%, the inductors may be in series with the caps, and not connected to the output port 510. The inductors 504, 506 may hold the current continuous (or substantially continuous) instead of the impulsive current through either capacitor 512, 514, and hence loss may be reduced. The flying capacitor 512 may be connected in series with the inductor 504 in a phase. At that same phase, the out-of-phase flying capacitor 514 is connected in series with the other inductor 506. In a next phase, the opposite scenario may occur. The flying capacitors 512, 514 form two RLC networks which may have a characterizing resonance frequency. Through such embodiment the output voltage may become the half of the input voltage Vᵢₙ.

Explicit inductance may be utilized to implement the inductors 504, 506. Besides, parasitic inductance may be used to implement the inductors 504 or 506. FIG. 6 illustrates an example power delivery path (or signal path) from an on-board VR (or signal source/sink) to a die. The power delivery system may include a voltage regulator 602, a decoupling capacitor 604, a printed circuit board (PCB) track/planes (horizontal structure) and vias (vertical structure) 606, a socket and package tracks/planes (horizontal structure) and vias (vertical structure) 608, an on-chip decoupling capacitance 610, and a load 612. The values indicated may vary depending on the system implemented and the technology scale available. The power delivery provides the desired voltage, routed through PCB tracks/vias 606 and through the socket and package tracks and vias 608, to the die. The capacitors 604, 610 may enhance power (signal) integrity by damping noise. Each element in the power delivery may be modeled by an equivalent parasitic inductance, resistance, and/or capacitance. Thus, such implicit inductance may be utilized to implement the capacitor 504 or 506 (FIG. 5).

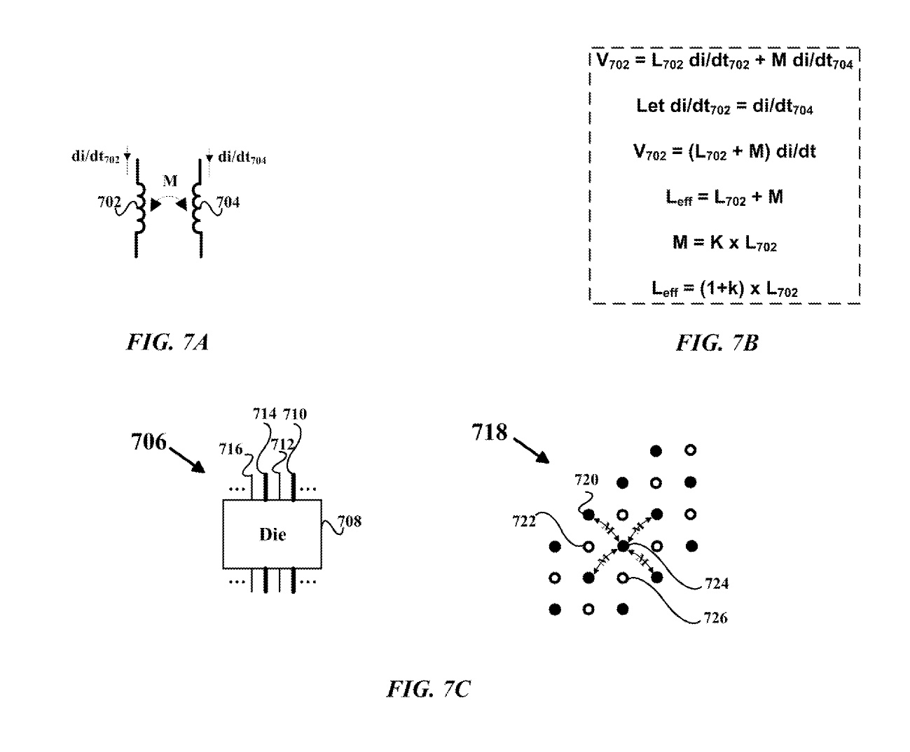

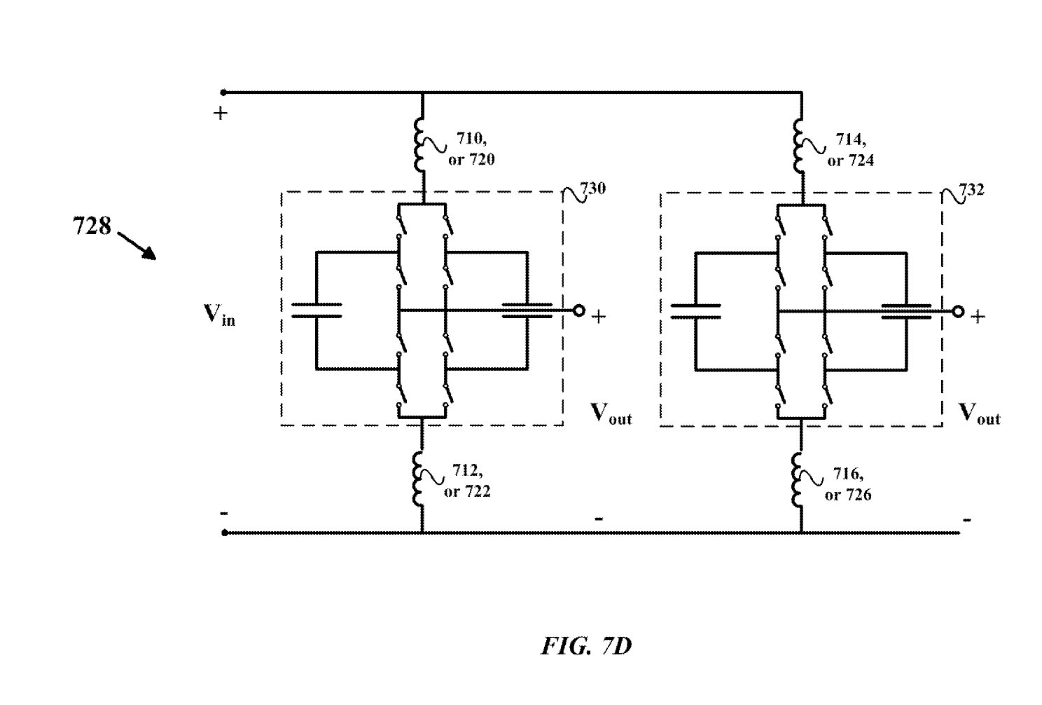

If an inductor is placed near another inductor a mutual inductance may result. FIG. 7A illustrates an example mutual coupling between two inductors 702, 704. Each inductor 702, 704 may have an equivalent self inductance L. A current change di/dt may occur in each inductor 702, 704. A mutual inductance M is resulted when the two inductors are placed near each other. FIG. 7B illustrates the effect of such mutual inductance M assuming the same current change, di/dt₇₀₂=di/dt₇₀₄, in each inductor for ease of illustration, where K is coupling coefficient. The effective inductance of the inductor 702 is boosted (enhanced) by a factor of 1+k. Thus, its Q-factor may be enhanced.

FIG. 7C illustrates an example power delivery subsystem for routing power (e.g. supply and ground) from outside to inside the package, e.g. the die. In arrangement 706, bond wires 710, 712 are used to deliver supply (e.g. an input voltage) and ground respectively to a die 708, which may follow a staggered structure. In arrangement 718, socket or package pins/holes/lands 720, 722 are used to deliver supply (e.g. an input voltage) and ground respectively to a die, which may follow a staggered structure, as may be possible to implement in some packaging structures, e.g. BGA, PGA, LGA, etc.

FIG. 7D illustrates an example switched circuit 728 utilizing parasitic inductors 710, 712, 714, 716, 720, 722, 724, 726 of FIG. 7C to provide continuous transformation ratios (modes) at 1/2, higher, or lower, e.g. 0≦Vₒᵤₜ/Vᵢₙ≦1, of an input voltage. The parasitic inductors 710, 712, 714, 716, 720, 722, 724, 726 may suffer from an inherent series resistance. The flying capacitors of the switched capacitor circuits 730, 732 may be on-chip decoupling capacitance. At the mode 1/2, each switched capacitor circuit 730, 732 aligns mutual coupling between the inductors 710, 712, 714, 716 (720, 722, 724, 726) and thus the mutual inductances may be utilized to enhance the effective inductance (and Q-factor) of the inductors. For instance, the inductor 712 may have a similar (or substantially similar) di/dt as the inductor 710 and 714, thus the effective inductance of 712 may be tripled (e.g. K˜1). The inductor 724 may have a similar (or substantially similar) di/dt as the eight direct neighbor inductors (including 720, 722, 726), thus the effective inductance of 724 may be enhanced by a factor of nine (e.g. K˜1). It should be noted that, the mutual coupling is only considered for direct neighbors for illustration. Besides the exact inductance multiplication factor is dependent on the exact dimensions (e.g. mutual coupling between 724 and 720 may be smaller than 724 and 722), shapes, etc.

At higher modes than 1/2, the current waveform of a supply inductor (e.g., 710 or 720) may not match the waveform of a ground inductor (e.g., 712 or 722) current. Thus, mutual coupling may be reduced at some instances of a cycle, decreasing the effective inductance. Fortunately, the ground inductor current may be continuous (or substantially continuous) and hence opposing inductive coupling to the supply inductor may be minimized.

Using the circuit 728 may provide an alternative decoupling system. The switches equivalent resistance of the switched capacitor circuits may damp power delivery network resonant peak, which may reduce the supply noise. Besides, through the circuit 728 the input/ground current is almost divided by two. Therefore, the load current 612 (FIG. 6) I_{L} and its steps ΔI_{L} may be halved, simplifying package/board power routing challenges where such challenges are dependent on I_{L} and ΔI_{L}. For instance, the number of supply/ground pins may be reduced (e.g. halved). On-package and PCB decoupling capacitors may be reduced. Package power planes may be reduced. On-board voltage regulators design may be relaxed where they are permitted to handle a smaller current (e.g. half the current).

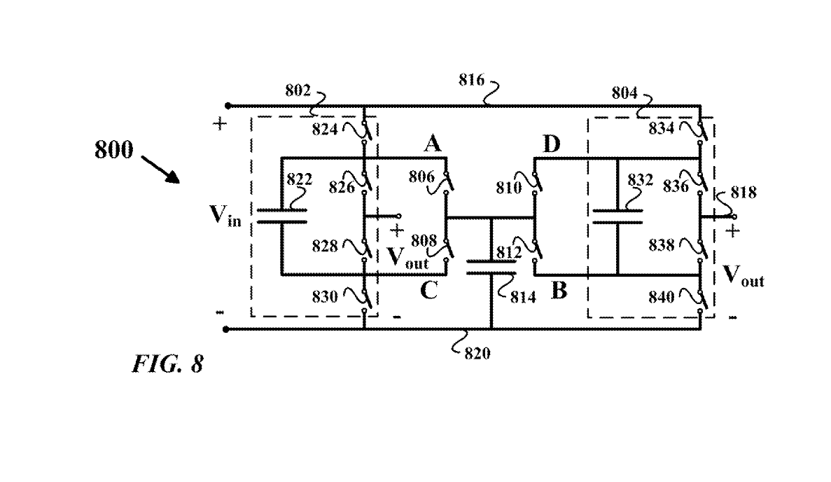

FIG. 8 illustrates an example switched capacitor circuit 800 that may be utilized to provide five voltage conversion ratios: 1/2, 2/3, 1/3, 3/4, and 1/4 of an input voltage Vᵢₙ. The circuit 800 may include two switched capacitor cells (e.g., 100) 802, 804, four reconfiguration switches 806, 808, 810, 812, a capacitor 814, an input port 816 to receive an input voltage (Vᵢₙ), an output port 818 to produce an output voltage Vₒᵤₜ, and a ground port 820. The cell 802 may include a flying capacitor 822, and four switches 824, 826, 828, 830. The cell 804 may include a flying capacitor 832, and four switches 834, 836, 838, 840. The cells 802, 804 are connected in cascade and the input voltage (Vᵢₙ) is provided across the cell 802. Each switched capacitor cell of the cells 802, 804 takes two inputs and produces, at the output port of the switched capacitor cell, an output voltage which is the average of the voltage at the input port and the ground port of the switched capacitor cell, (V_{input port}+V_{ground port})/2.

When the reconfiguration switches 806, 808, 810, 812 are disabled (gated) and the other switches 824, 826, 828, 830 (834, 836, 838, 840) are operated as the switches 106, 108, 110, 112, respectively in the circuit 100 (FIG. 1A) the cells 802, 804 are connected in parallel and to the output port 818 of the circuit 800. Therefore, the mode 1/2 may be produced at the output port 818.

When the switches 826, 828 are disabled (gated) the switches 824, 806, 808, 830 may be operated as the switches 106, 108, 110, 112, respectively in the circuit 100 (FIG. 1A). Besides, the switch 812 may be operated in place of the switch 840. Therefore, the cell 804 is connected between the input port 816 and the output port of the previous cell 802, and the mode 3/4 may be produced at the output port 818. When the cell 804 is connected between the output port of the previous cell 802 and the ground port 820, by replacing the switch 834 with 810, the mode 1/4 may be produced at the output port 818.

When the switches 824, 828, 834, 838 are closed and the other switches 826, 830, 806, 808, 810, 812, 836, 840 are open the capacitors 822, 832 are connected in parallel and between the input port 816 and the output port 818. When the switches 836, 812, 806, 830 are closed and the other switches 824, 826, 828, 808, 810, 834, 838, 840 are open the capacitors 832, 822 are connected in series and between the output port 818 and the ground port 820. The switch groups 824/828/834/838, 836/812/806/830 are switched on and off alternatively at a constant frequency. Therefore, the voltage conversion ratio 2/3 may be produced at the output port 818.

When the switches 824, 808, 810, 838 are closed and the other switches 826, 828, 830, 806, 812, 834, 836, 840 are open the capacitors 822, 832 are connected in series and between the input port 816 and the output port 818. When the switches 826, 830, 836, 840 are closed and the other switches 824, 828, 806, 808, 810, 812, 834, 838 are open the capacitors 822, 832 are connected in parallel and between the output port 818 and the ground port 820. The switch groups 824/808/810/838, 826/830/836/840 are switched on and off alternatively at a constant frequency. Therefore, the voltage conversion ratio 1/3 may be produced at the output port.

It should be noted that in the 2/3, 1/3 modes the series switches 806, 812 or 808, 810 may be replaced by one switch between nodes A, B or C, D, respectively. The elimination of series connected switches might enhance the efficiency and might reduce cost.

Referring back to FIG. 8, when the switches 806, 808 are operated in place of the switches 826, 828 the output of the cell 802 is provided to the capacitor 814. Besides, when the switch 828 is operated in place of the switch 830 the ground port of the cell 802 becomes the output port 818. When the switch 810 is operated in place of the switch 834 the input port of the cell 804 becomes connected to the capacitor 814. Thus, the cell 802 is stacked on top of the cell 804 and hence the circuit 800 may provide a 3:1 voltage conversion ratio.

Referring back to FIG. 8, when the switches 806, 808 are operated in place of the switches 826, 828 the output of the cell 802 is provided to the capacitor 814. Besides, when the switch 826 is operated in place of the switch 824 the input port of the cell 802 becomes the output port 818. When the switch 812 is operated in place of the switch 840 the ground port of the cell 804 becomes connected to the capacitor 814. Thus, the cell 804 is stacked on top of the cell 802 and hence the circuit 800 may provide a 3:2 voltage conversion ratio.

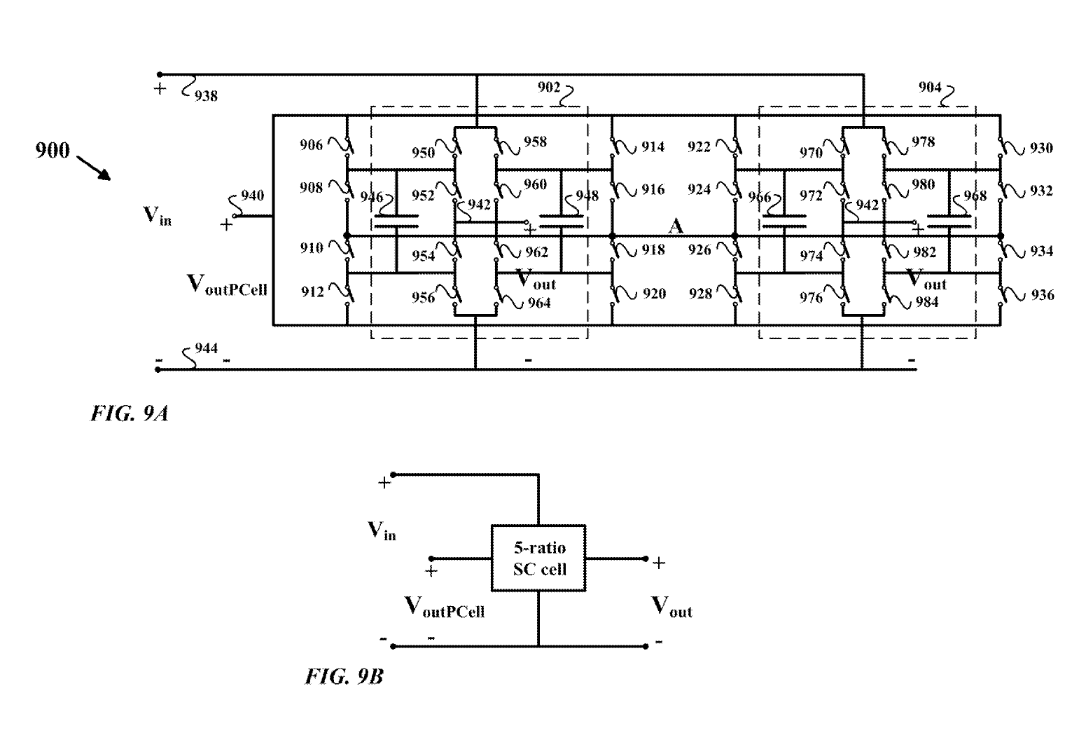

The capacitor 814 may be removed by using out-of-phase cells for 802, 804 (e.g. 200). FIG. 9A illustrates an example switched capacitor circuit 900 that may be utilized to provide five voltage conversion ratios: 1/2, 2/3, 1/3, 3/4, and 1/4 of an input voltage Vᵢₙ. FIG. 9B illustrates a block diagram of the circuit 900. The circuit 900 may include two switched capacitor cells (e.g., 200) 902, 904, sixteen reconfiguration switches 906-936, two input ports 938, 940 to receive an input voltage (Vᵢₙ) and a previous cell output (V_{outPCell}) respectively, an output port 942 to produce an output voltage (Vₒᵤₜ), and a ground port 944.

The cell 902 may include two flying capacitors 946, 948, eight switches 950-964. The cell 904 may include two flying capacitors 966, 968, eight switches 970-984. The input side and the ground side reconfiguration switches are embedded within the cells 902, 904. The input port and the ground port of the cell 902 (904) are connected to the input port 938 and the ground port 944, respectively. The output ports of the cells 902, 904 are connected in parallel to the output port 942. The reconfiguration switches 906, 914, 922, 930 are connected to the port 940 and the reconfiguration switches 912, 920, 928, 936 are connected to the port 940. The reconfiguration switch pair 908/910 is connected together to the node A, similarly the switch pairs 916/918, 924/926, 932/934.

Each switched capacitor cell of the cells 902, 904 takes two inputs and produces, at the output port of the switched capacitor cell, an output voltage which is the average of the voltage at the input port and the ground port of the switched capacitor cell, (V_{input port}+V_{ground port})/2. The cell 902 might be connected between: the input port 938 and the ground port 944, the output port 940 of the previous cell and the ground port 944, or the input port 938 and the output port 940 of the previous cell. Similarly for the cell 904 and besides the cell 904 may be connected between: the output port of the previous cell 902 (node A) and the ground port 944, or the input port 938 and the output port of the previous cell 902 (node A).

When the reconfiguration switches 906-936 are disabled (gated) and the cells 902, 904 are operated as the circuit 200 (FIG. 2A) the mode 1/2 may be produced at the output port 942, Vᵢₙ/2. When the switch pair 906/914 is operated in place of the switch pair 950/958 (the switches 950, 958 are disabled) and the switch pair 922/930 is operated in place of the switch pair 970/978 (the switches 970, 978 are disabled) the cells 902, 904 are connected between the output port 940 of the previous cell and the ground port 944. When the switch pair 912/920 is operated in place of the switch pair 956/964 (the switches 956, 964 are disabled) and the switch pair 928/936 is operated in place of the switch pair 976/984 (the switches 976, 984 are disabled) the cells 902, 904 are connected between the input port 938 and the output port 940 of the previous cell. In these three states, the cells 902, 904 provide the average of the voltage at the input port and the ground port of the switched capacitor cell (V_{input port}+V_{ground port})/2, i.e. and the circuit 900 may provide a 1/2 voltage conversion ratio.

When the reconfiguration switches 906, 912, 914, 920 are disabled (gated) and the switches 908, 910, 916, 918 are operated in place of the switches 952, 954, 960, 962, respectively, the cell 902 may produce the mode 1/2 at the node A, Vᵢₙ/2. When the switch pair 924/932 is operated in place of the switch pair 970/978 (the switches 970, 978 are disabled) the cell 904 is connected between the output port (node A) of the previous cell 902 and the ground port 944, thus the mode 1/4 may be produced at the output port 942. When the switch pair 926/934 is operated in place of the switch pair 976/984 (the switches 976, 984 are disabled) the cell 904 is connected between the input port 938 and the output port (node A) of the previous cell 902, thus the mode 3/4 may be produced at the output port 942. A similar approach may be followed to produce the modes 1/4, 3/4 while the input port 938 is replaced by the output port 940 of the previous cell through replacing the switch pair 950/958 by 906/914 and the switch pair 970/978 by 922/930 (if 3/4 mode); or while the ground port 944 is replaced by the output port 940 of the previous cell through replacing the switch pair 956/964 by 912/920 and 976/984 by 928/936 (if 1/4 mode).

The flying capacitors 946, 948 are out of phase to guarantee continuous input current, similarly the flying capacitors 966, 968. The flying capacitors 946, 966 (948, 968) may be in phase and hence may be operated to produce the 2/3 mode. For instance, when the switches 950, 954, 970, 974 are enabled and the switches 952, 956, 972, 976 are disabled the flying capacitors 946, 966 are connected in parallel between the input port 938 and the output port 942. When the switches 952, 910, 924, 976 are enabled and the switches 906, 908, 912, 950, 954, 956, 922, 926, 928, 970, 972, 974 are disabled the flying capacitors 946, 966 are connected in series and between the output port 942 and the ground port 944. Therefore, the 2/3 mode may be produced at the output port 942. When the switch 906 is operated in place of the switch 950 (the switch 950 is disabled) and the switch 922 is operated in place of the switch 970 (the switch 970 is disabled) the cells 902, 904 are connected between the output port 940 of the previous cell (instead of the input port 938) and the ground port 944 and may provide a 2/3 mode. When the switch 928 is operated in place of the switch 976 (the switch 976 is disabled) the cells 902, 904 are connected between the input port 938 and the output port 940 of the previous cell (instead of the ground port 944) and may provide a 2/3 mode. A similar approach may be followed for the flying capacitors 948, 968 to create an out-of-phase cell providing a 2/3 mode.

The flying capacitors 946, 948 are out of phase to guarantee continuous input current, similarly the flying capacitors 966, 968. The flying capacitors 946, 966 (948, 968) may be in phase and hence may be operated to produce the 1/3 mode. For instance, when the switches 950, 910, 924, 974 are enabled and the switches 906, 908, 912, 952, 954, 956, 922, 926, 928, 970, 972, 976 are disabled the flying capacitors 946, 966 are connected in series between the input port 938 and the output port 942. When the switches 952, 956, 972, 976 are enabled and the switches 950, 954, 970, 974 are disabled the flying capacitors 946, 966 are connected in parallel and between the output port 942 and the ground port 944. Therefore, the 1/3 mode may be produced at the output port 942. When the switch 906 is operated in place of the switch 950 (the switch 950 is disabled) the cells 902, 904 are connected between the output port 940 of the previous cell (instead of the input port 938) and the ground port 944 and may provide a 1/3 mode. When the switch 912 is operated in place of the switch 956 (the switch 956 is disabled) and the switch 928 is operated in place of the switch 976 (the switch 976 is disabled) the cells 902, 904 are connected between the input port 938 and the output port 940 of the previous cell (instead of the ground port 944) and may provide a 1/3 mode. A similar approach may be followed for the flying capacitors 948, 968 to create an out-of-phase cell providing a 1/3 mode.

It should be noted that in the 2/3, 1/3 modes the series connected switches (e.g., 910, 924) may be replaced by one switch. The elimination of series connected switches might enhance the efficiency and may reduce cost.

As in the circuit 800 (FIG. 8), the cell 902 may be stacked on top of the cell 904 and the stacked cells 902, 904 are in between the input port 938 and the ground port 944, thus the circuit 900 may provide a 3:1 voltage conversion ratio of Vᵢₙ. Similarly, the stacked cells 902, 904 may be in between the input port 938 and the output port 940 of the previous cell (instead of the ground port 944) while the stack is providing a 3:1 mode of. Besides, the stacked cells 902, 904 may be in between the output port 940 of the previous cell (instead of the input port 938) and the ground port 944 while the stack is providing a 3:1 mode. A similar description may be followed when the cell 904 is stacked on top of the cell 902 providing a 3:2 voltage conversion ratio.

I presently contemplate for the circuit 900 that the flying capacitance of the successive cells 902, 904 might be weighted of the circuit 900 total flying capacitance in order to provide optimal relative sizing of the successive capacitances, in the various modes, and hence higher efficiency can be achieved for certain total flying capacitance C of the circuit 900 and similarly for the optimal relative sizing of switches conductance.

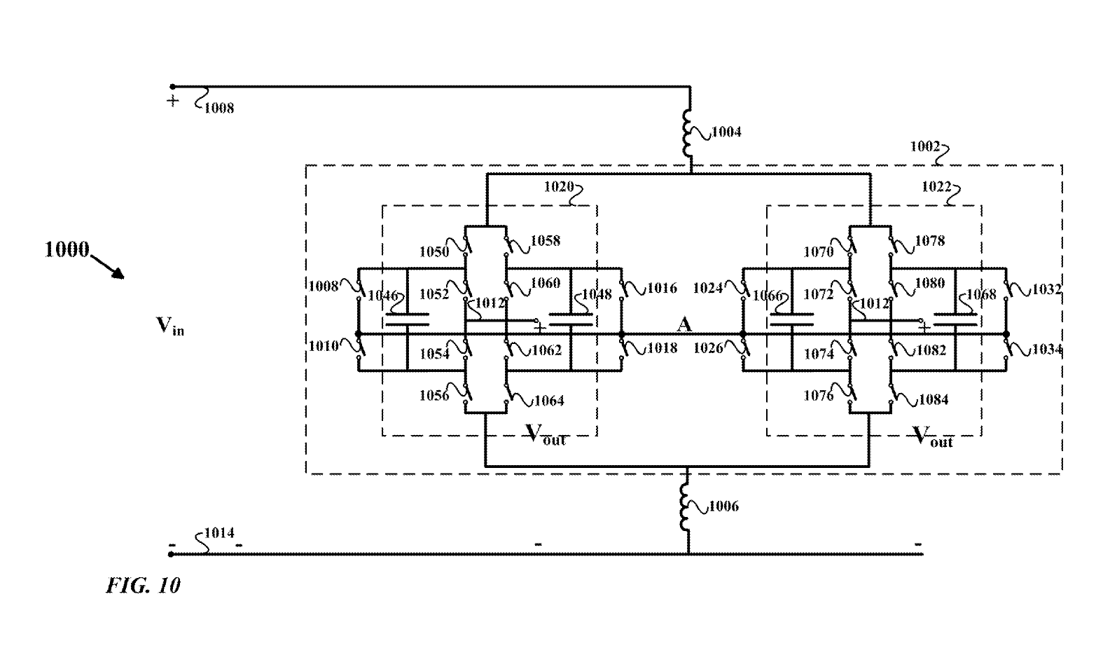

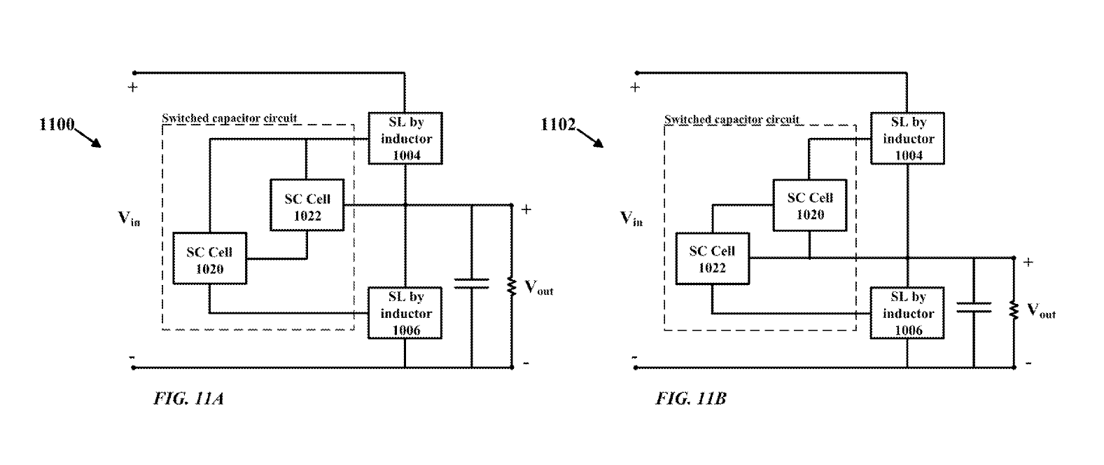

FIG. 10 illustrates an example switched circuit 1000 providing continuous transformation ratios (modes), e.g. 0≦Vₒᵤₜ/Vᵢₙ≦1, of an input voltage by using the switched capacitor circuit (e.g., 900) of five transformation modes 1/2, 2/3, 1/3, 3/4, and 1/4. The previous cell output port 940 may be removed and its associated eight switches 906, 914, 922, 930, 912, 920, 928, 936. The circuit 1002 may be operated in the mode 2:1 and hence the two switched capacitor cells 1020, 1022 may be operated as the circuit 500 (FIG. 5) providing continuous transformation ratios (modes) at 1/2, higher, or lower, e.g. 0≦Vₒᵤₜ/Vᵢₙ≦1. Similarly, the cells 1020, 1022 may be operated as the circuit 500 (FIG. 5) while the cell 1020 is providing its output at node A and the input port and the ground port of the cell 1022 is either connected between the input inductor 1004 and the node A, respectively, or the node A and the ground inductor 1006, respectively. As a result, the circuit 1000 may provide continuous transformation ratios (modes) at 3/4, higher, or lower, e.g. 0≦Vₒᵤₜ/Vᵢₙ≦1, and at 1/4, higher, or lower, e.g. 0≦Vₒᵤₜ/Vᵢₙ≦1.

The flying capacitors 1046, 1048 are out of phase to guarantee continuous input current, similarly the flying capacitors 1066, 1068. The flying capacitors 1046, 1066 (1048, 1068) may be in phase and hence may be operated to produce the 2/3 mode for the switched capacitor cells 1020, 1022. For instance, when the switches 1050, 1054, 1070, 1074 are enabled and the switches 1052, 1056, 1072, 1076 are disabled the flying capacitors 1046, 1066 are connected in parallel and in series with the inductor 1004. When the switches 1050, 1052, 1070, 1072, are enabled and the switches 1054, 1056, 1074, 1076 are disabled the inductor 1004 is connected between the input port 1008 and the output port 1012. When the switches 1052, 1010, 1024, 1076 are enabled and the switches 1008, 1050, 1054, 1056, 1026, 1070, 1072, 1074 are disabled the flying capacitors 1046, 1066 are connected in series and both are in series with the inductor 1006. A similar approach may be followed for the flying capacitors 1048, 1068 to create an out-of-phase cell providing a 2/3 mode. The resulted four (considering the out-of-phase 2/3 operation) mentioned states (phases) may be repeated at a constant frequency.

The duty cycle D of the switches 1052, 0160, 1072, 1080 may be proportional with the desired conversion ratio to provide modes at 2/3 or higher, e.g. Vₒᵤₜ/Vᵢₙ≧2/3. It should be noted that other switch signaling (timing) may be possible as well, e.g. instead of disconnecting the flying capacitors 1046, 1066 (1048, 1068 in the out-of-phase providing 2/3) when the inductor 1004 is directly connected to the output port 1012, the switches 1050, 1052, 1010, 1024, 1076 may be enabled while the other switches are disabled to connect the inductor 1004 directly to the output 1012 while the two capacitors 1046, 1066 are connected in series and both are in series with the inductor 1006.

The circuit 1000 may be operated to provide modes at 2/3 or lower, e.g. Vₒᵤₜ/Vᵢₙ≦2/3. When the switches 1050, 1054, 1070, 1074 are enabled and the switches 1052, 1056, 1072, 1076 are disabled the flying capacitors 1046, 1066 are connected in parallel and in series with the inductor 1004. When the switches 1052, 1010, 1024, 1076 are enabled and the switches 1008, 1050, 1054, 1056, 1026, 1070, 1072, 1074 are disabled the flying capacitors 1046, 1066 are connected in series and both are in series with the inductor 1006. When the switches 1074, 1076 are enabled and the switches 1070, 1072 and one switch of 1052, 1010, 1024 are disabled the inductor 1006 is connected between the output port 1012 and the ground port 1014. A similar approach may be followed for the flying capacitors 1048, 1068 to create an out-of-phase cell providing a 2/3 mode. The resulted four (considering the out-of-phase 2/3 operation) mentioned states (phases) may be repeated at a constant frequency. The duty cycle (1−D) of the switches 1074, 1082 may be inversely proportional with the desired conversion ratio to provide modes at 2/3 or lower, e.g. Vₒᵤₜ/Vᵢₙ≦2/3.

The flying capacitors 1046, 1048 are out of phase to guarantee continuous input current, similarly the flying capacitors 1066, 1068. The flying capacitors 1046, 1066 (1048, 1068) may be in phase and hence may be operated to produce the 1/3 mode for the switched capacitor cells 1020, 1022. For instance, when the switches 1050, 1010, 1024, 1074 are enabled and the switches 1008, 1052, 1054, 1056, 1026, 1070, 1072, 1076 are disabled the flying capacitors 1046, 1066 are connected in series and both are in series with the inductor 1004. When the switches 1050, 1052, are enabled and the switches 1054, 1056 and one switch of 1010, 1024, 1074 are disabled the inductor 1004 is connected between the input port 1008 and the output port 1012. When the switches 1052, 1056, 1072, 1076 are enabled and the switches 1050, 1054, 1070, 1074 are disabled the flying capacitors 1046, 1066 are connected in parallel and between the output port 1012 and the ground port 1014. A similar approach may be followed for the flying capacitors 1048, 1068 to create an out-of-phase cell providing a 1/3 mode. The resulted four (considering the out-of-phase 1/3 operation) mentioned states (phases) may be repeated at a constant frequency.

The duty cycle D of the switch 1052 may be proportional with the desired conversion ratio to provide modes at 1/3 or higher, e.g. Vₒᵤₜ/Vᵢₙ≧1/3. It should be noted that other switch signaling (timing) may be possible as well, e.g. instead of disconnecting the flying capacitors 1046, 1066 (1048, 1068 in the out-of-phase providing 1/3) when the inductor 1004 is directly connected to the output port 1012, the switches 1050, 1052, 1056, 1072, 1076 may be enabled while the other switches are disabled to connect the inductor 1004 directly to the output 1012 while the two capacitors 1046, 1066 are connected in parallel and both are in series with the inductor 1006.

A similar approach may be followed for the circuit 1000 to provide modes at 1/3 or lower, e.g. Vₒᵤₜ/Vᵢₙ≦1/3.

As described in FIG. 9A, the cell 1020 may be stacked on top of the cell 1022 and the stacked cells 1020, 1022 are in between the input inductor 1004 and the ground inductor 1006, thus the switched capacitor circuit 1002 may provide a 3:1 voltage conversion ratio of Vᵢₙ. By operating the cell 1020 as the circuit 300 (FIG. 3A) while the cell 1022 is operated as the circuit 200 (50% duty cycle for the switches) the inductor 1004 may be utilized for the circuit 1000 to provide modes at 1/3 or higher, e.g. Vₒᵤₜ/Vᵢₙ≧1/3. Similarly, by operating the cell 1020 as the circuit 200 (50% duty cycle for the switches) while the cell 1022 is operated as the circuit 400 (FIG. 4A) the inductor 1006 may be utilized for the circuit 1000 to provide modes at 1/3 or lower, e.g. Vₒᵤₜ/Vᵢₙ≦1/3.

A similar description may be followed when the cell 1022 is stacked on top of the cell 1020 providing a 3:2 voltage conversion ratio.

FIG. 11 illustrates an example equivalent circuit 1100 for the circuit 1000 when the switched capacitor circuit 1002 is operated in the mode 3/4 (FIG. 11A) and when the switched capacitor cells 1020, 1022 are stacked to provide the mode 1/3 (FIG. 11B). While not illustrated the load may be switched from being connected to the output port of the cell 1022 to being connected to the output port of the cell 1020 by utilizing some type of switching mechanism thus the switched capacitor circuit may provide the mode 2/3. It should be noted that, when higher modes than the fixed mode of the switched capacitor circuit are produced the SL created by the inductor 1006 may not be switched (connected) to the output port (Vₒᵤₜ). Similarly, when lower modes than the fixed mode of the switched capacitor circuit are produced the SL created by the inductor 1004 may not be switched to the output port (Vₒᵤₜ).

Further switched capacitor cells may be cascaded as in 1100 or stacked as in 1102 or cascaded and stacked to provide higher voltage resolution. It should be noted that the cascade of the two cells in 1100 may produced 1/4, 1/2, 3/4 modes, and hence by further connecting a third cell in cascade, either between the input port of the cell 1020 and the output port of the cell 1022 or between the output port of the cell 1022 and the ground port of the cell 1020), with the two cells 1020, 1022 in 1100 may produce eight modes: 1/8, 1/4, 3/8, 1/2, 5/8, 3/4, 7/8, with Vₘ/2³ voltage resolution. IF four cells are cascaded 2⁴-1 modes may be produced of Vᵢₙ/2⁴ voltage resolution, etc. Similarly, voltage resolution is enhanced when a third cell is stacked with the two cells in 1102, or further with a fourth cell, etc.

In another embodiment, multiple cells of 5-ratios (modes) as in 8A or 9A are stacked on top of each other. Multiple outputs may be provided through the output ports of the stacked cells to various loads simultaneously. Besides, with enough ratios available in such embodiment the various output voltages provided to the loads operating simultaneously may be controlled independently from each other, e.g. a bottom cell is providing a fixed voltage at certain level while a higher output port voltage is changing by reconfiguring the mode of one or more intermediate cells. A similar description may follow for multiple cascaded cells, each of multiple ratios.

It should be noted that one of the inductors 1100, 1102 may be removed. Embodiments were illustrated on two phase switched capacitor circuits, e.g. 100 where a flying capacitor 102 is charged in one phase of the switches clock and discharged in the second phase of the clock, however similar embodiments and illustrations may follow for multi-phase switched capacitor circuits. Besides, the inductor 1004 or 1006 may be placed between switched capacitor cells, rather than at the input port and the ground port of the circuit 1100 or 1102, where it is connected in two or more states (phases) to mitigate the fixed conversion ratio of a switched capacitor circuit. In such embodiments the inductor may handle a small portion of the load current I_{L} while the capacitors handles all of I_{L}. Besides, the inductor may process a small portion of I_{L} and Vᵢₙ that is proportional to the required deviation (fine regulation) from the switched capacitor fixed ratio (coarse regulation). Thus, the current change ΔI through the inductor and the direct-current (DC) current through the inductor equivalent resistance may be minimized. As a result, the losses within the inductor may be reduced, which may be of importance for integrated circuits inductors. Despite the embodiments were illustrated using one inductor, e.g. 1004 or 1006, to provide mitigation of the fixed ratio for a switched capacitor cell, more than one inductor may be utilized to provide such mitigation.

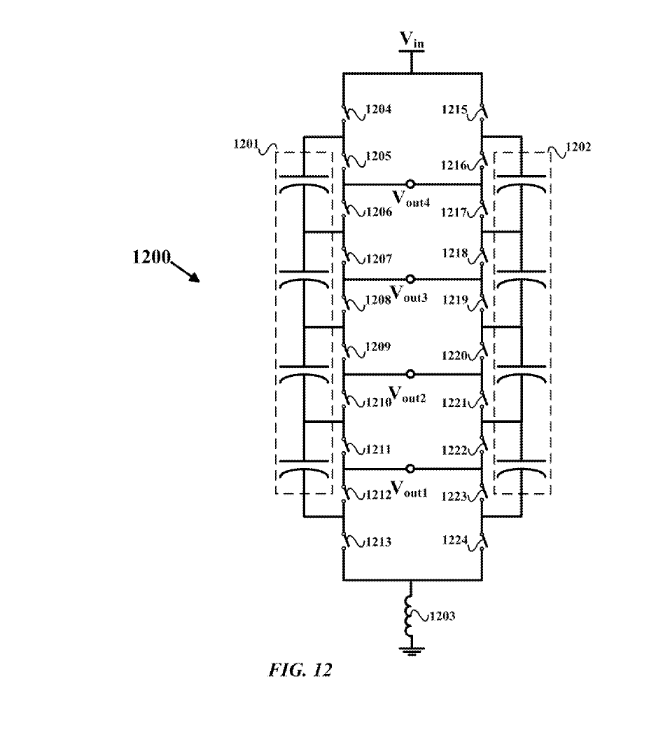

It should be noted that the switched capacitor circuit within the circuits 1100, 1102 may follow one or more of the switched capacitor topologies in prior art (e.g., Ladder topology, Dickson charge pump, Fibonacci topology, Series-Parallel topology, Doubler topology, etc.), one of the switched inductor topologies in prior art (e.g. buck topologies, boost topologies, transformer bridge topologies, etc.), or one of the embodiments. The overall voltage conversion ratio provided by the circuits 1100, 1102 may be larger or smaller than one and depends on the number of cells, the connection of the cells (e.g., stacked and/or cascaded), the mode each cell is operated at, and the placement of load (where Vₒᵤₜ is connected). For instance, FIG. 12 illustrates an example of the usage of inductors with a Ladder switched capacitor topology.

FIG. 12 illustrates an example switched circuit 1200 providing continuous transformation ratios (modes) using a Ladder topology of five steps (e.g. 1/5, 2/5, 3/5, 4/5, 1). The circuit 1200 may include two flying capacitor ladders 1201, 1202, an inductor 1203, and twenty switches 1204-1213 and 1215-1224. The even numbered switches may be on while the odd numbered switches are off and vice versa. The on duration is approximately half of the cycle time. The modes 1/5, 2/5, 3/5, 4/5 may be provided from the nodes Vₒᵤₜ₁, Vₒᵤₜ₂, Vₒᵤₜ₃, Vₒᵤₜ₄, respectively.

When the even switches are enabled while the odd switches are disabled the ladder 1201 is connected between Vᵢₙ and Vₒᵤₜ₁ while the ladder 1202 is connected between Vₒᵤₜ₄ and the inductor 1203. When the even switches of 1204-1213, and the switches 1223, 1224 are enabled while the other switches 1215-1222 are disabled the ladder 1201 is connected between Vᵢₙ and Vₒᵤₜ₁ while the inductor 1203 is connected between Vₒᵤₜ₁ and the ground. Similarly, when the odd switches are enabled while the even switches are disabled the ladder 1202 is connected between Vᵢₙ and Vₒᵤₜ₁ while the ladder 1201 is connected between Vᵢₙ and Vₒᵤₜ the inductor 1203. When the odd switches of 1215-1223, and the switches 1212, 1213 are enabled while the other switches 1204-1211 are disabled the ladder 1202 is connected between Vᵢₙ and Vₒᵤₜ₁ while the inductor 1203 is connected between Vₒᵤₜ₁ and the ground. These four mentioned states (phases) may be repeated at a constant frequency. It should be noted that other switch signaling (timing) may be possible as well.

The duty cycle of the switches 1213, 1224 may be proportional with the desired conversion ratio to provide modes at 1/5 or lower, 2/5 or lower, 3/5 or lower, and 4/5 or lower, at Vₒᵤₜ₁, Vₒᵤₜ₂, Vₒᵤₜ₃, and Vₒᵤₜ₄, respectively.

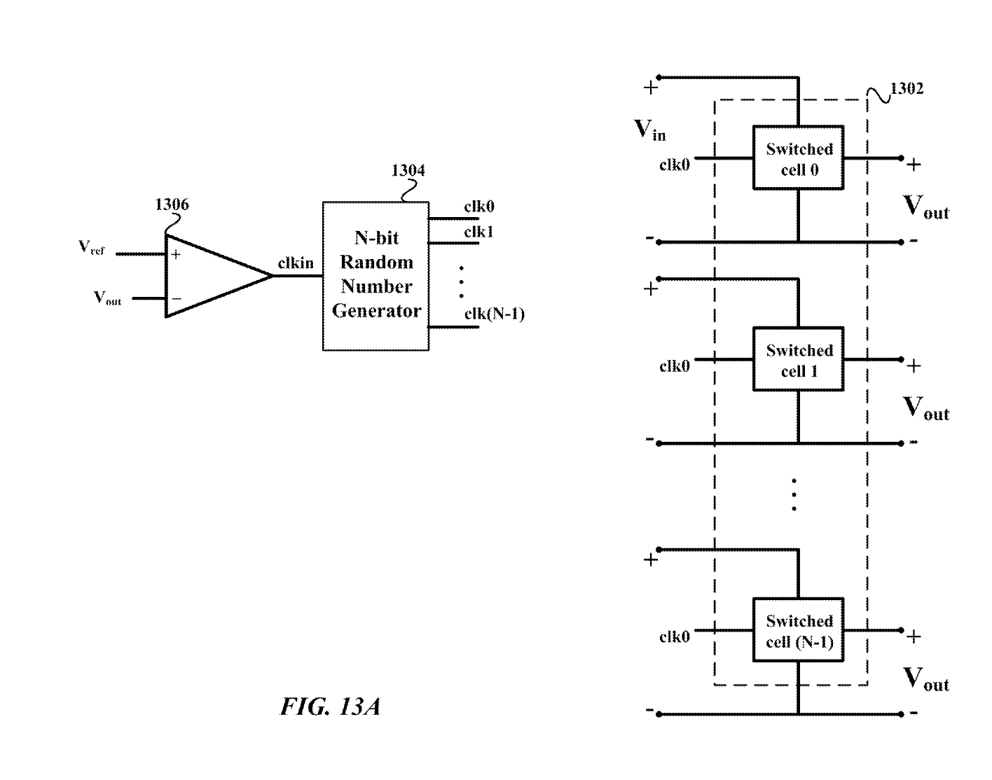

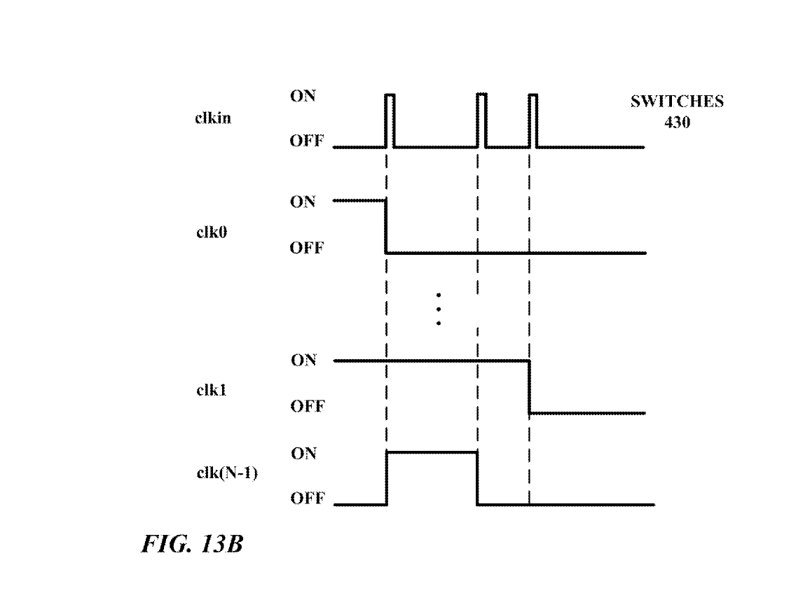

FIG. 13A illustrates an example method for reducing noise of a switched circuit. The method may include segmenting the switched circuit 1302 into a set of smaller size dephased switched cells, providing 1304 random frequency switch driving clocks, and comparing 1306 the output voltage (Vₒᵤₜ) with a reference voltage (V_{ref}). The switched cells 1302 may not be identically sized. The switch timing for each switched cell is provided through an N-bit random number generator 1304, where at each edge of the clock (clkin) a random number is generated. The produced number may differ from the previous number by a single bit change or multiple bits changes. The comparator provides a clock edge (clkin) each time the output falls below the reference voltage V_{ref}. Thus, when a cell or more is switched with a new generated number a charge is injected in an output capacitor (not shown) which results in output voltage Vₒᵤₜ jump above V_{ref}. When the output voltage Vₒᵤₜ falls below V_{ref} the comparator 1306 produces a next edge for the clock clkin. At that edge a new random number is generated and hence the duration between consecutive edges for the clock clkin may differ randomly. As a result, the random frequency hopping may eliminate (or substantially eliminate) any spurious tones (converter switching noise). Besides, in time domain the peak-to-peak output voltage Vₒᵤₜ ripple may be minimized.

FIG. 13B illustrates an example timing of the driving clocks clk0, clk1, clk(N−1). At each clock pulse of clkin one or more switched cells are switched. The duration between clock pulses of clkin may be random.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment. The various embodiments are intended to be protected broadly within the spirit and scope of the appended claims.

What is claimed:

1. A direct-current to direct-current (DC-DC) converter adapted for converting a plurality of input voltages to a plurality of output voltages, comprising:
a. a plurality of capacitors,
b. a plurality of inductors, and
c. a plurality of switches, and
d. said switches interconnect said capacitors creating a switched capacitor circuit capable of operating at one of a plurality of distinct conversion ratios, wherein said plurality of inductors provide continuous modes from the plurality of distinct ratios and selection of an overall converter mode is based on an input voltage received.

2. The DC-DC converter of claim 1, wherein said plurality of inductors handles a fraction of a load current wherein such fraction may be proportional to the deviation from said plurality of distinct conversion ratios.

3. The DC-DC converter of claim 1, wherein the timing of said switches determines the deviation from said plurality of distinct conversion ratios.

4. The DC-DC converter of claim 1, wherein said inductors are parasitic inductances of a signal delivery system.

5. The DC-DC converter of claim 1, wherein said inductors couple together enhancing their effective inductance.

6. The DC-DC converter of claim 4, wherein vertical and horizontal structures of said signal delivery system are arranged to maximize mutual coupling between said inductors.

7. The DC-DC converter of claim 1, wherein said switched capacitor circuit further includes a plurality of switched cells connected in cascade, in a stack, or both.

8. An apparatus to receive a plurality of input voltages and generate a plurality of output voltages, wherein the apparatus is capable of operating at one of continuous voltage conversion ratios and selection of said one of the available continuous voltage conversion ratios is based on an input voltage received, the apparatus comprising: a plurality of capacitors, a plurality of inductors, and a plurality of switches which create a plurality of switched cells connected in cascade, in a stack, or in cascade and in a stack, wherein each switched cell is capable of operating in one of a plurality of modes.

9. The apparatus of claim 8, wherein said plurality of inductors provides fine regulation from the switched capacitor cells fixed modes.

10. The apparatus of claim 8, wherein said plurality of inductors provides substantially continuous current through said capacitors.

11. The apparatus of claim 08, wherein operation of said plurality of switches is used to select the voltage conversion ratio of the apparatus.

12. The apparatus of claim 8, wherein selection of said one of a plurality of modes for each of the cells is based on said one of the available continuous voltage conversion ratios.

13. The apparatus of claim 8, wherein placement of load is used to select said one of the available continuous voltage conversion ratios.

14. The apparatus of claim 8, wherein the number of said switched cells is reduced by disconnecting at least one of said plurality of switched cells to select said one of the available continuous voltage conversion ratios.

15. The apparatus of claim 08, wherein the number of said switched cells is reduced by connecting at least two of said plurality of switched cells in parallel to select said one of the available continuous voltage conversion ratios, whereby no switched cell is disconnected.

16. The apparatus of claim 8, wherein at least one subset of said switched cells connected in cascade is changed to a second arrangement in stack, or vice versa, to select said one of a plurality of voltage conversion ratios.

17. The apparatus of claim 8, wherein said switched cells are operated respectively at a plurality of switching frequencies.

18. The apparatus of claim 8, wherein at least two subsets of said plurality of switched cells utilize at least one another subset of said plurality of switched cells in common to provide a plurality of independent output ports from said at least two subsets.

19. A method of generating a spurious noise free power from a switched circuit adapted for converting a plurality of input voltages to a plurality of output voltages, the method comprising: segmenting the switched circuit into a set of smaller dephased switched cells, providing random switch driving clocks to said dephased switched cells, and comparing the output voltage with an input voltage received to trigger the random number generation.
